(19) United States
(12) Patent Application Publication
(10) Pub. No.: US 2014/0295944 A1
(43) Pub. Date: Oct. 2, 2014

(54) METHOD, SYSTEM, AND COMPUTER PROGRAM PRODUCT FOR MATCHING, AGGREGATING, AND COMPARING PATRONAGE COMP OFFERS FOR USERS OF CASINOS

(71) Applicant: Brandon Faircloth, Youngsville, LA (US)

(72) Inventor: Brandon Faircloth, Youngsville, LA (US)

(21) Appl. No.: 14/209,157

(22) Filed: Mar. 13, 2014

Related U.S. Application Data
(60) Provisional application No. 61/788,053, filed on Mar. 15, 2013.

(51) Int. Cl. G07F 17/32

(52) U.S. Cl. CPC G07F 17/3255
USPC 463/25

(57) ABSTRACT

A method, system, and computer readable code are provided in which comp offers are created and matched to patrons of casinos based on custom patron preferences. Comps are created by casinos, sent to a content management system, and aggregated based on patron preferences sent to the content management system via a location-capable wireless network.

The comps may be delivered in the form of a push notification that may be sent to a specific place at a specific time. Casinos may create a push notification and send the push notification to the content management system. In conjunction with a third party geocache system, content management system may deliver push notifications to location-capable wireless devices found in a geofenced area at a designated time.

### CROSS-REFERENCE TO RELATED APPLICATIONS

This applications claims priority to U.S. Provisional Patent Application Ser. No. 61/788,053, filed Mar. 15, 2013, which is hereby incorporated by reference in its entirety.

### FIELD OF THE INVENTION

The present disclosure relates to a method, system, and computer program product for matching, aggregating, and comparing patronage comp offers for users of casinos.

### BACKGROUND OF THE INVENTION

Complimentary items or “Comps” are an important part of modern day gambling. They allow a casino to attract new potential gamblers as well as keep current gamblers coming back to the casino.

The amount of comps that a player is given usually directly correlates to what game a user plays, how long a user plays games, and how much a user typically bets during a game.

Traditionally, casinos award comps based on a player's theoretical loss. The theoretical loss is the amount of money a player is expected to lose based on the long run statistical advantage the casino has on the particular game being played.

Theoretical loss is calculated as follows:

Theoretical loss=(Casino Advantage)×(Total Wager)

Most casinos nowadays require that a player have a player's club card, loyalty card, etc. in order to track the play history of the player and the comps awarded to the player.

In recent years, many casinos have fallen under hard times due to the recession that has occurred within the past couple of years. Casinos have been doing everything that they can in order to draw in new customers and keep a stellar relationship with current patrons.

Therefore, a need exists for a simple system that helps casinos compete and bring in previously inaccessible potential customers while at the same time giving the potential customers easy access to comps for a casino.

### BRIEF SUMMARY OF THE INVENTION

CompMyPlay™ (CMP) is a social engine for gaming and entertainment enthusiasts. Through its mobile app and website interface, CMP identifies and aggregates the best comp offers for users (subscribers) to compare, so casinos can compete for their patronage.

CompMyPlay™ operates based on a complex relational database, and is driven by a content management system (CMS). From the user perspective, CMP's core functionality is to facilitate customized comp searches tailored to the user interests and playing habits. The CMP back-end system correlates interest and behavior information stored in a user's profile with the tags and criteria attached to a comp offer by a casino to assemble custom comp packages for each user search.

For casinos, CMP is a valuable channel to bring new players into their establishment and generate repeat traffic. By tapping into CMP's vast “pre-qualified” user network, casinos are able to market to a wider net, enabling them to engage with players they wouldn't otherwise have access to.

The CMP content management system is flexible and can be accessed at anytime by CMP personnel and casino clients who have been issued admin accounts. In order to protect the integrity of the database, each casino client is given a separate portal area within the CMS restricted to their info, and casino admin privileges are a sub-set of those held by CMP staff. The CMS, as well as the user experience, may be accessed from the website as well as from the mobile application.

After creating an initial profile, users can search for comp offers through the “In the Area” portal for comps being offered at that time (expiring within 24 hours) in their particular geography (up to within a 300 mile GPS radius from the user's current location).

The user can bookmark comps that interest them and go back to them later in the “Comps” folder; any saved offers that have passed their expiration date will automatically disappear.

If a user accepts a comp offer, a voucher with the COMPMYPLAY code is generated. The user must redeem the voucher with the casino establishment in order to “cash in” comp. All comp offers generated through CMP can be tracked using the COMPMYPLAY code, giving both CMP and the casino client insight into the rate of return and perceived value. Users can access their accepted comp packages and their associated vouchers at any time in their “My Comps” folder.

To discourage “double-dipping” when planning a trip by accepting multiple comp packages from competing casinos that are never redeemed, CMP only allows users to accept one comp package at a time on a “Plan a Trip” search. If a comp package has already been accepted, the user must first cancel the previously accepted comp prior to accepting a new one.

The CMP app offers users additional features beyond comp search. CMP's navigation enables users to easily browse upcoming events by CMP client casino in the “Events Calendar”; access the loyalty cards stored in the user's “M-Wallet”; or go to the “My Profile” tab to edit personal information, update comp interests and change their push preferences. Users will be able to “pause” push offers from being pushed to their phone. The app will generate a notification on the user's phone home screen or to their email at defined intervals with a reminder to change their push offer setting back to “play” before they play.

Accordingly, it is one object of the current disclosure to quickly and efficiently deliver comp offers to qualified users of the application. Another object of the current disclosure is to allow casino personnel the ability to manage casino accounts.

These and other aspects of the disclosed subject matter, as well as additional novel features, will be apparent from the description provided herein. Provided, however, any particular embodiment need not contain all of the aspects and an aspect or aspects, in any possible combination, from one embodiment may be implemented in another embodiment and remain within the scope of this disclosure. Furthermore, any particular aspect may be removed from one or more embodiments and remain within the scope of this disclosure. The intent of this summary is not to be a comprehensive description of the subject matter, but rather to provide a short overview of some of the subject matter's functionality. Other systems, methods, features and advantages here provided will become apparent to one with skill in the art, who has the benefit of this invention's teachings, upon examination of the following FIGURES and detailed description. It is intended that all such additional systems, methods, features and advantages that are included within this description, be within the scope of any claims herein or filed later.

### BRIEF DESCRIPTION OF THE DRAWINGS

Novel and nonobvious features believed characteristic of the disclosed subject matter will be set forth in claims that follow. The disclosed subject matter itself, however, as well as certain particular modes of use, further objectives, and advantages thereof, will be understood by reference to the following detailed description of illustrative embodiments when read in conjunction with the accompanying drawings, wherein:

FIG. 1 depicts a computer system and related peripherals that may operate with the comp matching, aggregating, and distributing service in accordance with one embodiment.

FIG. 2A depicts an electronic device with a storage structure capable of encoding comps for a comp receiving application in accordance with one embodiment.

FIG. 2B depicts an electronic device with a storage structure capable of encoding comps for a comp receiving application (wherein the application is found on the electronic device) in accordance with one embodiment.

FIG. 3 depicts a simpler block layout of the electronic device of FIG. 2A and FIG. 2B in accordance with one embodiment.

FIG. 4 depicts a screen image from an electronic device 30 depicting the welcome page 100 for the comp allotting application in accordance with one embodiment.

FIG. 5 depicts a screen image from an electronic device 30 depicting the log-in page 110 for the comp allotting application in accordance with one embodiment.

FIG. 6 depicts a screen image from an electronic device 30 depicting the verify age page 120 for the comp allotting application in accordance with one embodiment.

FIG. 7A depicts a screen image from an electronic device 30 depicting the first create account page 130 for the comp allotting application in accordance with one embodiment.

FIG. 7B depicts a screen image from an electronic device 30 depicting a filled out create account page 130 for the comp allotting application in accordance with one embodiment.

FIG. 7C depicts a screen image from an electronic device 30 depicting the second create account page 140 for the comp allotting application in accordance with one embodiment.

FIG. 8A depicts a screen image from an electronic device 30 depicting the loyalty card section 150 for the comp allotting application in accordance with one embodiment.

FIG. 8B depicts a screen image from an electronic device 30 depicting the loyalty card information page 160 for the comp allotting application in accordance with one embodiment.

FIG. 9 depicts a screen image from an electronic device 30 depicting the loyalty cards generation page 170 for the comp allotting application in accordance with one embodiment.

FIG. 10A depicts a screen image from an electronic device 30 depicting the generated loyalty cards page 180 for the comp allotting application in accordance with one embodiment.

FIG. 10B depicts a screen image from an electronic device 30 depicting the loyalty card individual card page 190 for the comp allotting application in accordance with one embodiment.

FIG. 11 depicts a screen image from an electronic device 30 depicting the M-Wallet page 200 for the comp allotting application in accordance with one embodiment.

FIG. 12 depicts a screen image from an electronic device 30 depicting the “My Chips” page 210 for the comp allotting application in accordance with one embodiment.

FIG. 13 depicts a screen image from an electronic device 30 depicting the start search page 220 for the comp allotting application in accordance with one embodiment.

FIG. 14 depicts a screen image from an electronic device 30 depicting the “In the Area” page 230 for the comp allotting application in accordance with one embodiment.

FIG. 15 depicts a screen image from an electronic device 30 depicting the generation page 240 for the comp allotting application in accordance with one embodiment.

FIG. 16 depicts a screen image from an electronic device 30 depicting the “In the Area” comp results page 250 for the comp allotting application in accordance with one embodiment.

FIG. 17 depicts a screen image from an electronic device 30 depicting the “In the Area” single comp page 260 for the comp allotting application in accordance with one embodiment.

FIG. 18 depicts a screen image from an electronic device 30 depicting the generated voucher page 270 for the comp allotting application in accordance with one embodiment.

FIG. 19 depicts a screen image from an electronic device 30 depicting the my comps page 280 for the comp allotting application in accordance with one embodiment.

FIG. 20 depicts a screen image from an electronic device 30 depicting the event calendar home page 290 for the comp allotting application in accordance with one embodiment.

FIG. 21 depicts a screen image from an electronic device 30 depicting the January events for Stutes Stars are in the form of a calendar 300 that is depicted below the drop down menus 291, 292 for the comp allotting application in accordance with one embodiment.

FIG. 22 depicts an electronic device 30 depicting a push offer screen image 310 for the comp allotting application in accordance with one embodiment.

FIG. 23 depicts a screen image from an electronic device 30 depicting the casino administration log-in page 400 for the comp allotting application in accordance with one embodiment.

FIG. 24 depicts a screen image from an electronic device 30 depicting the reset password page 410 for the comp allotting application in accordance with one embodiment.

FIG. 25 depicts a screen image from an electronic device 30 depicting the casino dashboard page 420 for the comp allotting application in accordance with one embodiment.

FIG. 26 depicts a screen image from an electronic device 30 depicting the comps statistics page 430 for the comp allotting application in accordance with one embodiment.

FIG. 27 depicts a screen image from an electronic device 30 depicting the reports download page 440 for the comp allotting application in accordance with one embodiment.

FIG. 28 depicts a screen image from an electronic device 30 depicting the casino info page 450 for the comp allotting application in accordance with one embodiment.

FIG. 29 depicts a screen image from an electronic device 30 depicting the marketing info page 460 for the comp allotting application in accordance with one embodiment.

FIG. 30 depicts a screen image from an electronic device 30 depicting the loyalty numbers page 470 for the comp allotting application in accordance with one embodiment.

FIG. 31 depicts a screen image from an electronic device 30 depicting the manage comps: active comps page 480 for the comp allotting application in accordance with one embodiment.

FIG. 32 depicts a screen image from an electronic device 30 depicting the manage comps: scheduled comps page 490 for the comp allotting application in accordance with one embodiment.

FIG. 33 depicts a screen image from an electronic device 30 depicting the manage comps: past comps page 500 for the comp allotting application in accordance with one embodiment.

FIG. 34 depicts a screen image from an electronic device 30 depicting the setup main location comp page 510 for the comp allotting application in accordance with one embodiment.

FIG. 35 depicts a flow diagram depicting the path of a comp from a casino to a matched user for the comp allotting application in accordance with one embodiment.

FIG. 36 depicts a screen image from an electronic device 30 depicting the send outbound comp page 520 for the comp allotting application in accordance with one embodiment.

FIG. 37 depicts a flow chart of the process of sending a comp push notification to a user's electronic device 30 for the comp allotting application in accordance with one embodiment.

FIG. 38 depicts a screen image from an electronic device 30 depicting a GPS map 530 for the comp allotting application in accordance with one embodiment.

FIG. 39 depicts a screen image from an electronic device 30 depicting the CompMyPlay™ Administration log-in page 600 for the comp allotting application in accordance with one embodiment.

FIG. 40 depicts a screen image from an electronic device 30 depicting the reset password page 610 for the comp allotting application in accordance with one embodiment.

FIG. 41 depicts a screen image from an electronic device 30 depicting the CompMyPlay™ Administration casino dashboard page 620 for the comp allotting application in accordance with one embodiment.

FIG. 42 depicts a screen image from an electronic device 30 depicting the comps statistics page 630 for the comp allotting application in accordance with one embodiment.

FIG. 43 depicts a screen image from an electronic device 30 depicting the reports download page 640 for the comp allotting application in accordance with one embodiment.

FIG. 44 depicts a screen image from an electronic device 30 depicting the CompMyPlay™ Administration manage casinos page 650 for the comp allotting application in accordance with one embodiment.

FIG. 45 depicts a screen image from an electronic device 30 depicting the edit casinos page 660 for the comp allotting application in accordance with one embodiment.

FIG. 46 depicts a screen image from an electronic device 30 depicting the CompMyPlay™ Administration add a casino page 670 for the comp allotting application in accordance with one embodiment.

FIG. 47 depicts a screen image from an electronic device 30 depicting the CompMyPlay™ Administration casinos master list page 680 for the comp allotting application in accordance with one embodiment.

### DETAILED DESCRIPTION OF ILLUSTRATIVE EMBODIMENTS

Reference now should be made to the drawings, in which the same reference numbers are used throughout the different figures to designate the same components.

It will be understood that, although the terms first, second, third, etc. may be used herein to describe various elements, these elements should not be limited by these terms. These terms are only used to distinguish one element from another element. Thus, a first element discussed below could be termed a second element without departing from the teachings of the present disclosure.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Although described with reference to personal computers and the Internet, one skilled in the art could apply the principles discussed herein to any computing or mobile computing environment. Further, one skilled in the art could apply the principles discussed herein to communication mediums beyond the Internet.

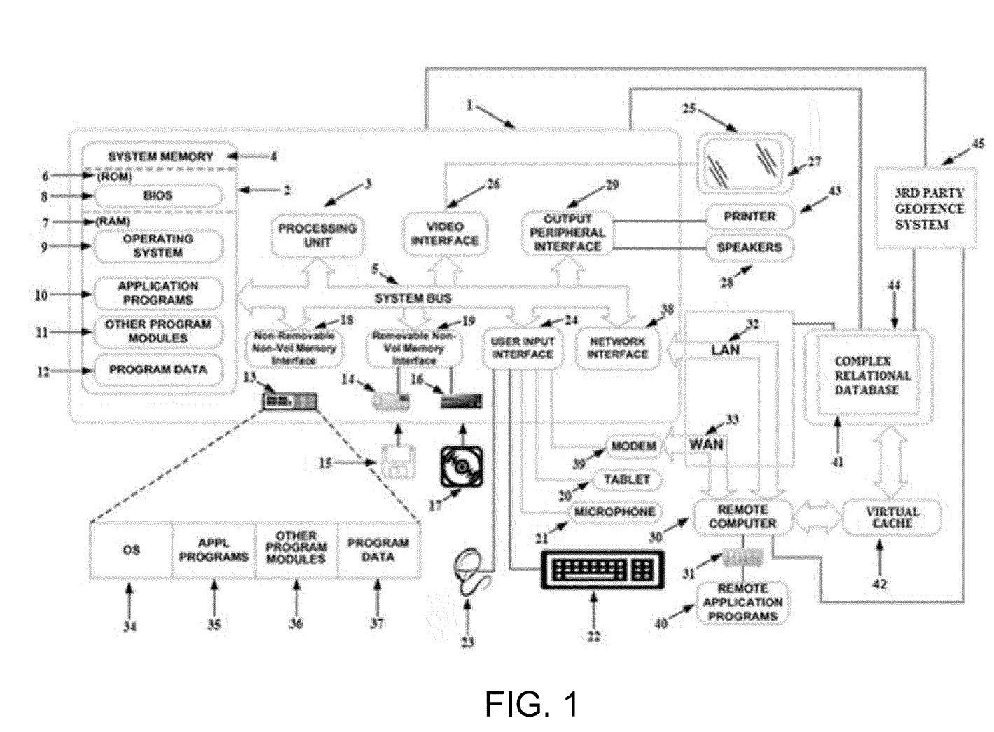

With reference to FIG. 1, an exemplary system within a computing environment for implementing the disclosure includes a general purpose computing device in the form of a computing system 1, commercially available from Intel, IBM, AMD, Motorola, Cyrix, etc. Components of the computing system 2 may include, but are not limited to, a processing unit 3, a system memory 4, and a system bus 5 that couples various system components including the system memory 4 to the processing unit 3. The system bus 5 may be any of several types of bus structures including a memory bus or memory controller, a peripheral bus, or a local bus using any of a variety of bus architectures.

Computing system 1 typically includes a variety of computer readable media. Computer readable media can be any available media that can be accessed by the computing system 1 and includes both volatile and nonvolatile media, and removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data.

Computer memory includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing system 1.

The system memory 4 includes computer storage media in the form of volatile and/or nonvolatile memory such as read only memory (ROM) 6 and random access memory (RAM) 7. A basic input/output system 8 (BIOS), containing the basic routines that help to transfer information between elements within computing system 1, such as during start-up, is typically stored in ROM 6. RAM 7 typically contains data and/or program modules that are immediately accessible to and/or presently being operated on by processing unit 3. By way of example, and not limitation, an operating system 9, application programs 10, other program modules 11 and program data 12 are shown.

Computing system 1 may also include other removable/non-removable, volatile/nonvolatile computer storage media. By way of example only, a hard disk drive 13 that reads from or writes to non-removable, nonvolatile magnetic media, a magnetic disk drive 14 that reads from or writes to a removable, nonvolatile magnetic disk 15, and an optical disk drive 16 that reads from or writes to a removable, nonvolatile optical disk 17 such as a CD ROM or other optical media could be employed to store the invention of the present embodiment. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 13 is typically connected to the system bus 5 through a non-removable memory interface such as interface 18, and magnetic disk drive 14 and optical disk drive 16 are typically connected to the system bus 5 by a removable memory interface, such as interface 19.

The drives and their associated computer storage media, discussed above, provide storage of computer readable instructions, data structures, program modules and other data for the computing system 1. For example, hard disk drive 13 is illustrated as storing operating system 34, application programs 35, other program modules 36 and program data 37. Note that these components can either be the same as or different from operating system 9, application programs 10, other program modules 11, and program data 12. Operating system 34, application programs 35, other program modules 36, and program data 37 are given different numbers here to illustrate that, at a minimum, they are different copies.

A user may enter commands and information into the computing system 1 through input devices such as a tablet, or electronic digitizer, 20, a microphone 21, a keyboard 22, and pointing device 23, commonly referred to as a mouse, trackball, or touch pad. These and other input devices are often connected to the processing unit 3 through a user input interface 24 that is coupled to the system bus 5, but may be connected by other interface and bus structures, such as a parallel port, game port or a universal serial bus (USB).

A monitor 25 or other type of display device is also connected to the system bus 5 via an interface, such as a video interface 26. The monitor 25 may also be integrated with a touch-screen panel or the like. Note that the monitor and/or touch screen panel can be physically coupled to a housing in which the computing system 1 is incorporated, such as in a tablet-type personal computer. In addition, computers such as the computing system 1 may also include other peripheral output devices such as speakers 27 and printer 43, which may be connected through an output peripheral interface 29 or the like.

Computing system 1 may operate in a networked environment using logical connections to one or more remote computers, such as a remote computing system 30. The remote computing system 30 may be a personal computer (including, but not limited to, mobile electronic devices), a server, a router, a network PC, a peer device or other common network node, and typically includes many or all of the elements described above relative to the computing system 1, although only a memory storage device 31 has been illustrated. The logical connections depicted include a local area network (LAN) 264 connecting through network interface 38 and a wide area network (WAN) 33 connecting via modem 39, but may also include other networks. Such networking environments are commonplace in offices, enterprise-wide computer networks, intranets and the Internet.

For example, in the present embodiment, the computer system 1 may comprise the source machine from which data is being generated/transmitted and the remote computing system 30 may comprise the destination machine. Note however that source and destination machines need not be connected by a network or any other means, but instead, data may be transferred via any media capable of being written by the source platform and read by the destination platform or platforms.

In another example, in the present embodiment, the remote computing system 30 may comprise the source machine from which data is being generated/transmitted and the computer system 1 may comprise the destination machine.

In a further embodiment, in the present disclosure, the computing system 1 may comprise both a source machine from which data is being generated/transmitted and a destination machine and the remote computing system 30 may also comprise both a source machine from which data is being generated/transmitted and a destination machine.

For the purposes of this disclosure, it is appreciated that the terms “device”, “processor based mobile device”, “mobile device”, “electronic device”, “processor based mobile electronic device”, “mobile electronic device”, and “location-capable wireless device” may be synonymous with remote computer 30.

The Content Management System 44, or CMS, is the main system utilized by the CompMyPlay™ administrators. It is responsible for the storage and organization of information relating to accounts created for casino members and individual members of the CompMyPlay™ program. Within the Content Management System 44 is the complex relational database, which is utilized to relate data pushed to the system from casino computing systems 1 and users' electronic devices 30. The Content Management System 44 may comprise one or more of the elements found in the computing system 1 in order to carry out the tasks and functions expected out of the Content Management System 44.

The central processor operating pursuant to operating system software such as IBM OS/2®, Linux®, UNIX®, Microsoft Windows®, Apple Mac OSX® and other commercially available operating systems provides functionality for the services provided by the present invention. The operating system or systems may reside at a central location or distributed locations (i.e., mirrored or standalone).

Software programs or modules instruct the operating systems to perform tasks such as, but not limited to, facilitating client requests, system maintenance, security, data storage, data backup, data mining, document/report generation and algorithms. The provided functionality may be embodied directly in hardware, in a software module executed by a processor or in any combination of the two.

Furthermore, software operations may be executed, in part or wholly, by one or more servers or a client's system, via hardware, software module or any combination of the two. A software module (program or executable) may reside in RAM memory, flash memory, ROM memory, EPROM memory, EEPROM memory, registers, hard disk, a removable disk, a CD-ROM, DVD, optical disk, or any other form of storage medium known in the art. An exemplary storage medium is coupled to the processor such that the processor can read information from, and write information to, the storage medium. In the alternative, the storage medium may be integral to the processor. The processor and the storage medium may also reside in an application specific integrated circuit (ASIC). The bus may be an optical or conventional bus operating pursuant to various protocols that are well known in the art.

A processor based mobile device, according to the present disclosure, may integrate several functionalities for providing a user interface by which a user may receive comp offers. The processor-based device may also be configured to communicate the accepted comp offer to a designated database (virtual cache) associated with the user interface. The various functions provided by an electronic device in accordance with embodiments of the present disclosure, as will be described in further detail below, may generally provide users a convenient tool for receiving and aggregating casino comps.

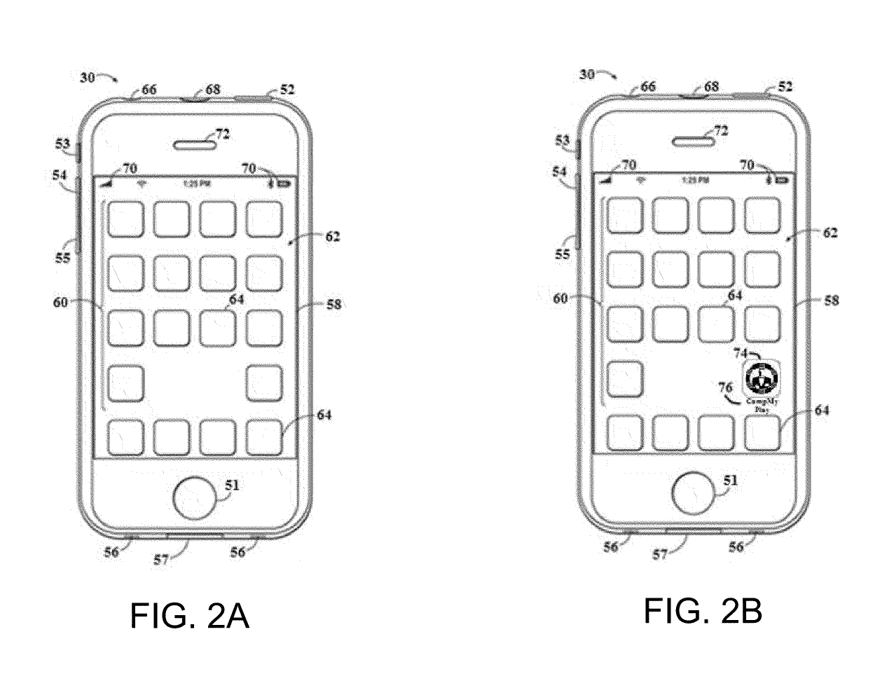

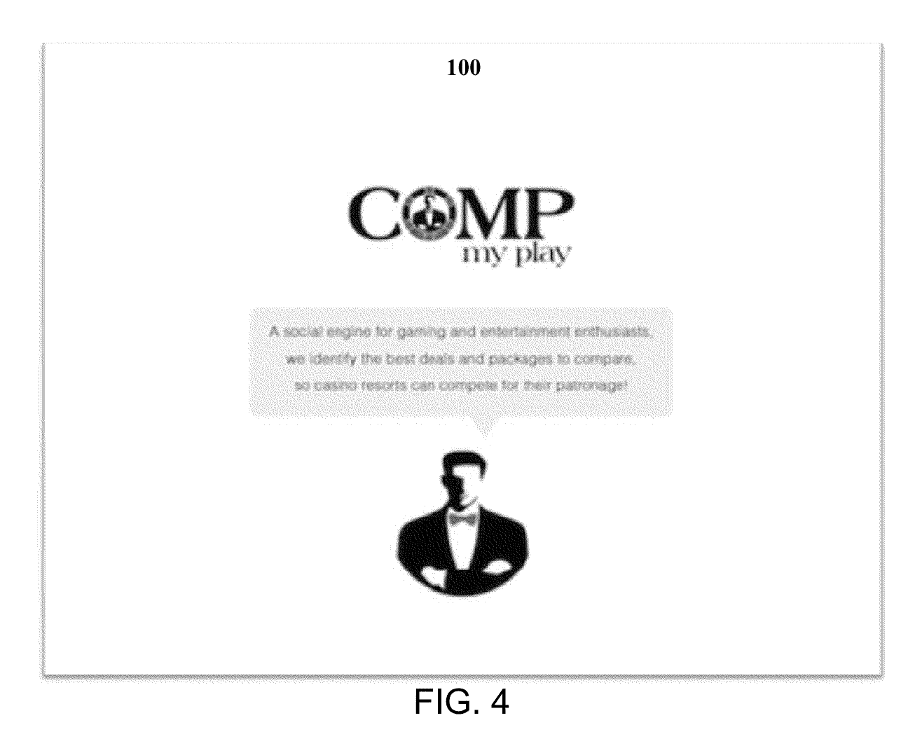

A handheld processor-based electronic device, according to the present invention, as in FIG. 2A, may include a casino comp application that may display the embodiments of displays described in FIG. 4 to FIG. 47. While certain techniques and embodiments described reference a handheld electronic device 30 (a cellular telephone, a personal data organizer, etc.), it is appreciated that the techniques and embodiments described may be implemented and/or displayed using any suitable type of electronic device capable of carrying out the previous task, including desktop computers, TVs, etc.

The electronic device 30 in FIG. 2A may be handheld and function as one or more portable devices (a cellular phone, a personal data organizer, etc.). While using the electronic device 30, a user may perform one or more tasks (listen to music, talk on the phone, etc.) at one time or at different times. The electronic device 30 may also allow a user to utilize the Internet. Further, the electronic device 30 may allow for wireless communication between a user and another entity using text messaging, email, etc.

The electronic device 30 includes various input complexes 51, 52, 53, 54, and 55. Using these input complexes, a user may alter an electronic device function located within the electronic device 30 when the input complexes 51, 52, 53, 54, and 55 are agitated. For example, the input complex 51 may light up the display 58 of the electronic device 30. Another example may include an input complex 53 that may switch a call alert tone in a cell phone application between vibrate mode and ring mode. The input complexes 54 and 55 may alter the volume for an application that uses volume on the electronic device 30. For the purposes of this disclosure, it is appreciated that the input complexes 51, 52, 53, 54, and 55 are examples and do not limit the disclosure as a whole in any way. The input complexes 51, 52, 53, 54, and 55 may also take the form of other structures not mentioned above.

A display 58 may be included in the electronic device 30 that may display images from the electronic device 30. Images that may be displayed include text messages, photos, and e-mails; the electronic device 30 is not limited to displaying only the above images. The display 58 may also display one or more device tokens 70 that show statuses of aspects of the electronic device 30, an example being a device token 70 for the strength of a cellular network (if the electronic device includes a cellular phone application). In certain embodiments, the display 58 may be any type of display 58, which includes a liquid crystal display (LCD), a light emitting diode (LED) display, an organic light emitting diode (OLED) display, etc. The display 58 may further include a touch sensitive device associated with the display 58 that may be interacted with by the touch of a user (and would be considered another input complex in addition to input complexes 51, 52, 53, 54, and 55).

A GUI 60, or “graphical user interface” may be programmed into the display 58 and be shown by the display 58. The GUI 60 may include various graphical layers, windows, screens, templates, elements, or other components that may be displayed on all or a portion of the display 58. For example, the GUI 60 may display more than one icon 64. These icons 64 may be viewed on the device's home screen 62.

In another embodiment, one or more of the user input complexes 51, 52, 53, 54, and 55 may be used to peruse the GUI 60 and steer away from the home screen 62. In a further embodiment, the touch screen interface may also be used to select the icons 64.

When a user engages an icon 64, an icon 64 may cover some or all of the display 58 and be representative of various layers, windows, screens, templates, elements, or other graphical components. In addition, a hierarchical screen navigation process may exist once an icon 64 is chosen. In one embodiment, an icon 64 that is chosen may cause the display 58 to display a screen inclusive of one or more other icons 64 or GUI elements. Furthermore, in the embodiment shown in FIG. 2A, vocabulary 76 representative of an icon 64 or another element may exist in the general area surrounding an icon 64 or another element. For example, the icon 74 for a casino comp application may further be represented by the vocabulary 76 “CompMyPlay”. For the purposes of this disclosure, it is appreciated that the GUI 60 may include various elements arranged in hierarchical and/or non-hierarchical structures.

An application may be open, initiated, or run (by the electronic device 30) when a user chooses an icon 64 associated with the aforementioned application. In one embodiment, the device 30 may open the casino comp application, which may provide for the reception of comps by the user of the electronic device 30 when the CompMyPlay™ icon 74 is chosen. When an application is chosen by a user, the display 58 may display one or more screens that may include various elements related specifically to the selected application.

Input/output (I/O) ports, for example I/O ports 57, 66, and 68, may exist in the electronic device 30. Using the I/O ports, the electronic device 30 may interact with one or more external devices. For example, the I/O port 66 may be an audio jack that could connect the electronic device 30 to speakers, headphones, etc. In an embodiment, the I/O port 68 may be configured to receive a subscriber identity module (SIM) card when the electronic device can be utilized as a cell phone. Another embodiment may include an I/O port as a connection port used to send and receive data. For the purposes of this disclosure, it is appreciated that there is no set number of I/O ports that are to be included on an electronic device 30 that may connect to any number of other devices including printers, power sources, computers, usb drives etc. The I/O ports may further take the shape suitable for being used in conjunction with any type of wired connection, such as a usb port.

In a further embodiment, more than one function may be performed by an I/O port. For example, I/O port 57 may have the capability to send and receive data as well as receive power from a power source, depending on what is connected to the electronic device 30.

In another embodiment, the electronic device 30 may include one or more audio I/O elements 56, 72, which may function as one or more input receivers and/or output transmitters. When used as an output transmitter, the one or more audio I/O elements 56, 72 may transmit sound to the user of the device, such as music from a music application. When used as an input receiver, the one or more audio I/O elements 56, 72 may receive sound, such as the voice of a user when the user is utilizing a phone application on the electronic device 30. The one or more audio I/O elements 56, 72 may further be used at the same time (when the electronic device 56, 72 is used as a cell phone, etc.).

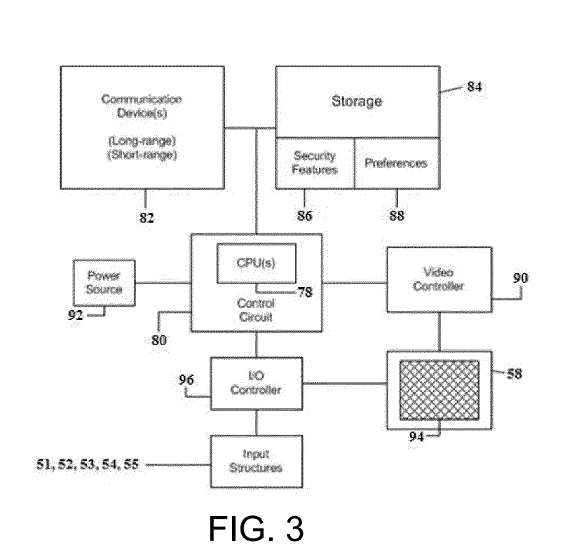

FIG. 3 depicts a basic layout of elements of the electronic device 30 in accordance with one embodiment of the present disclosure. The device 30 may include the above discussed display 58, as well as a CPU 78, a touch screen interface 94, an I/O controller 96, a storage device 84, one or more communication interfaces 82, a video controller 90, control circuitry 80, and a power source 92.

The central processing unit (CPU) 78 and the control circuit 80 may control the operation of the electronic device 30. In conjunction, these elements may provide the processing capability required to execute an operating system, application programs (“apps”), the GUI 60, and any other functions provided on the device 30. The control circuit 80 may include one or more data buses for transferring data and instructions between components of the device 30. The control circuit 80 also may further include on board memory (RAM) for caching purposes.

The CPU 78 may include one or more processors. For example, the CPU 78 may include “general purpose” microprocessors, a combination of general and application-specific microprocessors, instruction set processors, graphics processors, video processors, as well as related chips sets and/or special purpose microprocessors. The device 30 may also include (not shown in FIG. 3) a standalone random access memory (RAM) in communication with the CPU 78 by way of one or more memory controllers, which may be integrated within the control circuit 80.

The CPU 78 may use information that may be stored within a long-term storage device, represented by reference numeral 84. The storage device 84 of the electronic device 30 may be utilized for storing data required for the operation of the CPU 78, data to be processed or executed by the CPU 78, as well as other data required by the electronic device 30, such as application and program data. For, example, the storage device 84 may be configured to store the firmware for the electronic device 30 that is used by the CPU 78. The firmware may include an operating system, as well as other programs or drivers that enable various functions of the electronic device 30, GUI functions, and/or processor functions. The storage device 84 may also store components for the GUI 60, such as graphical elements, screens, and templates. The storage device 84 may also store data files such as media (e.g., music and video files), image data, application software, preference information (e.g., media playback preferences, general user preferences), network connection information (e.g., information that may enable the electronic device 30 to establish a wireless connection, such as a telephone or Internet connection), subscription information (e.g., information that maintains a record of television shows or other media to which a user subscribes), telephone information (e.g., telephone numbers), and any other suitable data required by the electronic device 30. The long term storage 84 may be non-volatile memory such as read only memory, flash or solid state memory, a hard disk drive, or any other suitable optical, magnetic, or solid-state computer readable media, as well as a combination thereof.

Included in the electronic device 30 may be one or more network communication devices 82 for providing additional connectivity channels for receiving and transmitting information. For example, the communication device 82 may represent a network controller as well as various associated communication protocols. The communication device 82 may provide for various long-range communication interfaces, such as a wireless local area network (WLAN) interface (e.g., an IEEE 802.11x wireless network), a local area network (LAN) interface 32, or a wide area network (WAN) interface 33. For example, a WAN interface 33 may permit a private and/or secure connection to a cellular data network, such as the 3G network. The network communication device 82 may further provide a short message service (SMS) interface.

The communication device 82 may further provide for short-range communication interfaces, such as a personal area network (PAN) interface. The PAN interface may provide capabilities to network with, for example, a Bluetooth® network or an ultra wideband network (UWB). The communication device 82 may include any number and combination of network interfaces. As will be acknowledged, the network device may employ one or more protocols, such as the High-Speed Downlink Packet Access (HSDPA) protocol, for rapidly downloading data over a network. The network communication device 82 may additionally allow the electronic device 30 to receive software upgrades.

The electronic device 30 may further include a service discovery networking protocol to establish a connection with an external device through a network interface in specific embodiments. For example, both the electronic device 30 and the external device may broadcast identification information using internet protocol standards (IP). The external device may additionally broadcast information relating to the available services the external device is capable of providing (e.g., printing services for a networked printer). The devices may then use the identification information to establish a network connection between the devices.

Properties of the above-mentioned communication interfaces provided by the network communication device 82 may further be determined by user preference settings 88. The user preference settings 88 may be stored in the storage device 84. For instance, the preferences 88 may include a list of networks that the electronic device 30 may connect to and may further govern the order or priority between the communication interfaces.

Further, the communication preferences associated with the preferences 88 may be further dependent upon security features 86 available for each respective communication interface. The security features 86 may be stored in the storage device 84 and may include one or more cryptographic protocols, such as a secure sockets layer (SSL) protocol or a transport layer security (TLS) protocol, for establishing secure communications between the electronic device 30 and an external device. The security features 86 may also include one or more encryption applications for encrypting information sent from the electronic device 30. These features may be particularly useful when transmitting information of a sensitive nature, which may generally include credit card and bank account information.

To limit access to the sensitive data, such as encryption keys, passcodes and passwords, digital certificates, or the like, the security features 86 may also include a secure access-restricted storage area (e.g., within the storage device 84). Additionally, in some embodiments, the secure storage area 84, in addition to storing the above-mentioned sensitive data, may be further protected by its own respective password or authorization “personal identification number” (PIN), for example, in order to prevent unauthorized access to the information stored therein.

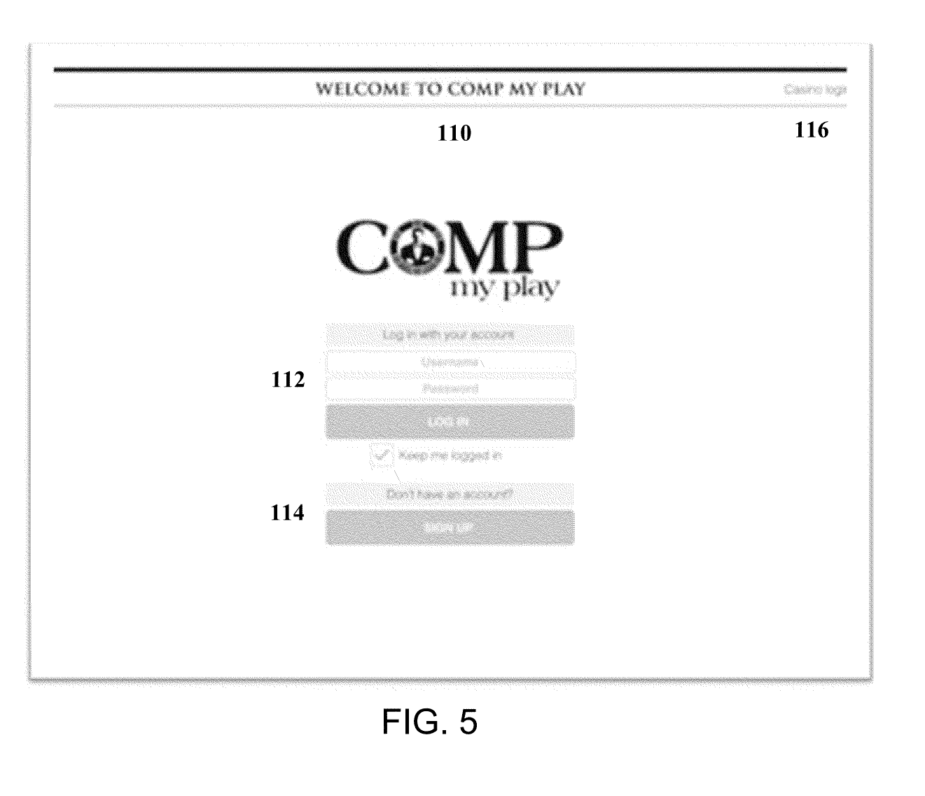

The video controller 90 may be operatively coupled to the display 58 and configured to receive image data and to send voltage signals corresponding to the pixel values of the image data to the display 58. The displayed image data may represent information received through the communication interface 82, as well as information contained in the storage device 84. As will be understood by those skilled in the art, pixel values may be numerical assignments corresponding to respective pixel intensities. Therefore, the display 58 may receive the voltage signals from the video controller 90 as an input and produce an image corresponding to the voltage signals. With reference to FIG. 5, an image produced by the signals provided by the video controller 90 may represent a screen of the GUI 60 described above.

A user may select various graphical elements which may represent applications or information that may be displayed through the GUI 60. A touch screen interface 94 may be positioned in front of or behind the display 58 and may provide a user the ability to select graphical elements, such as the icons 64 displayed by the GUI 60 as in FIG. 2A and FIG. 2B. The touch screen interface 90 may be configured to receive inputs based on a physical contact (e.g., touching the display 58 when engaging an icon) either by the user or an object (e.g., stylus) being controlled or manipulated by the user, and to send “touch event” information to the CPU 78. The CPU 78 may then process the detected touch event information and perform a corresponding action. For example, referring briefly back to FIG. 2A and FIG. 2B, the “touching” of the icon 64 may be processed by the CPU 78 as an instruction to execute or initiate the corresponding application. The touch screen interface 94 may employ any suitable type of touch screen technology such as resistive, capacitive, infrared, surface acoustic wave, electromagnetic, or near field imaging. The touch screen interface 94 may further include single point or multipoint sensing.

A user may communicate with the CPU 78 through various input structures utilizing the infrastructure provided by the I/O controller 96. The input structures provided on the electronic device 30 include input complexes represented by the reference numerals 51, 52, 53, 54, and 55 as shown in FIG. 2A and FIG. 2B. The user input structures 51, 52, 53, 54, and 55 may be used in conjunction with, or independently of, the touch screen interface 94 to provide input information to the electronic device 30.

The electronic device 30 may be powered by the power source 92 in both non-portable and portable settings. In a portable setting, for instance, in order to facilitate transport and ease of motion, the electronic device 30 may include an integrated power source 92 for powering the electronic device 30. The power source 92 may include one or more batteries, such as a Li-Ion battery, which may be user-removable or secured to the electronic device 30. In specific embodiments, the proprietary connection I/O port 57 may be used to connect the electronic device 30 to a power source in order to recharge the battery. In other embodiments, the one or more batteries may be non-integrated and may include one or more rechargeable or replaceable batteries. Further, in a non-portable setting, the power source 92 may include AC power, such as provided by an electrical outlet.

Generally, depicted screen images may be generated by the GUI 60 and displayed on the display 58. For instance, these screen images may be generated as the user interacts with the electronic device 30, such as via the input structures 51, 52, 53, 54, and 55, and/or the touch screen interface 94. As discussed above, the GUI 60, depending on the inputs and selections made by a user, may display various screens including icons (e.g., 64) and graphical elements. These elements may represent graphical and virtual elements or “buttons” which may be selected by the user by physically touching their respective location on the display 58 using the touch screen interface 94, for example. Further, the functionalities set forth and described in the subsequent figures may be achieved using a wide variety of graphical elements and visual schemes. Thus, it should also be understood that the present disclosure is not intended to be limited to the precise user interface conventions depicted herein. Embodiments of the present invention may include a wide variety of GUI 60 styles.

I. User Experience

FIG. 4 depicts a screen image from an electronic device 30 depicting the welcome page 100 for the comp allotting application in accordance with one embodiment. Starting with the home screen 62, a user may initiate the comp allotting application by selecting the CompMyPlay™ icon 74 on the display of the electronic device 30. Upon selecting the CompMyPlay™ icon 28, the welcome page 100 may be displayed on the electronic device 30. The welcome screen includes a man in a tuxedo that explains what the comp allotting application is and what it accomplishes. In alternative screens, the tuxedo man will pop up in order to provide an overview of certain application features and functionality as well as guidance through the user experience.

FIG. 5 depicts a screen image from an electronic device 30 depicting the log-in page 110 for the comp allotting application in accordance with one embodiment. Once the welcome screen 100 is engaged by a user, the display 20 may display the log-in page. The log-in page 110 may include two main sections: a log-in section 112 and a sign-up section 114. In the current screen image, the log-in section 112 displays two fillable sections where a user may enter their username and password related to the user's CompMyPlay™ account. Below the fillable sections is a checkable box adjacent to the statement “Keep me logged in”, allowing a user to stay logged in even if the user navigates away from the CompMyPlay™ social engine. If a user does not have a username and password associated with a CompMyPlay™ account, the user may utilize the sign-up section 114 by engaging the “SIGN UP” icon. The user will then be taken to a screen image where the user may create a CompMyPlay™ account. If a user is associated with a casino account, the user may log in by engaging the casino login icon 116 at the top right corner of the screen.

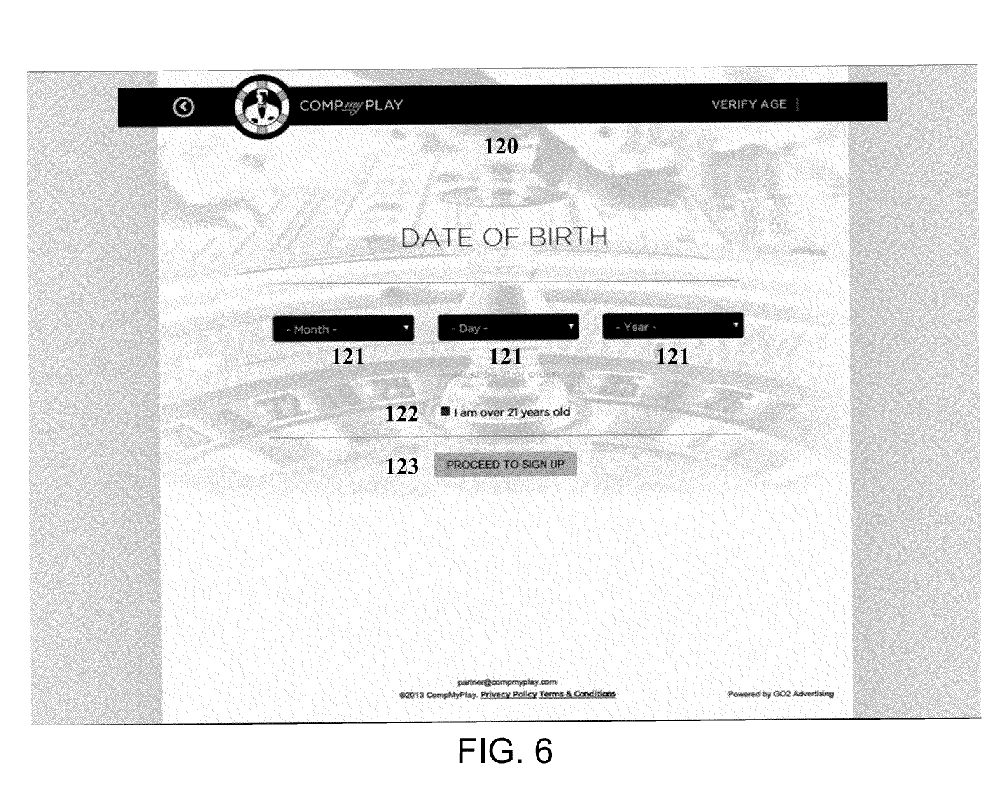

FIG. 6 depicts a screen image from an electronic device 30 depicting the verify age page 120 for the comp allotting application in accordance with one embodiment. In order to be able to continue to another page in the CompMyPlay™ application, a user must verify their age/date of birth using the pull-down tabs 121 and the “Age 21” verification engageable check box 122. Once the user has entered a date that allows the user to be over 21 years of age and engaged the check box, the user may engage the sign up icon 123 in order to be led to another page found in the application. If a user does not enter a date that would imply that the user is older than 21 years of age, the user may be restricted from accessing further pages in the application.

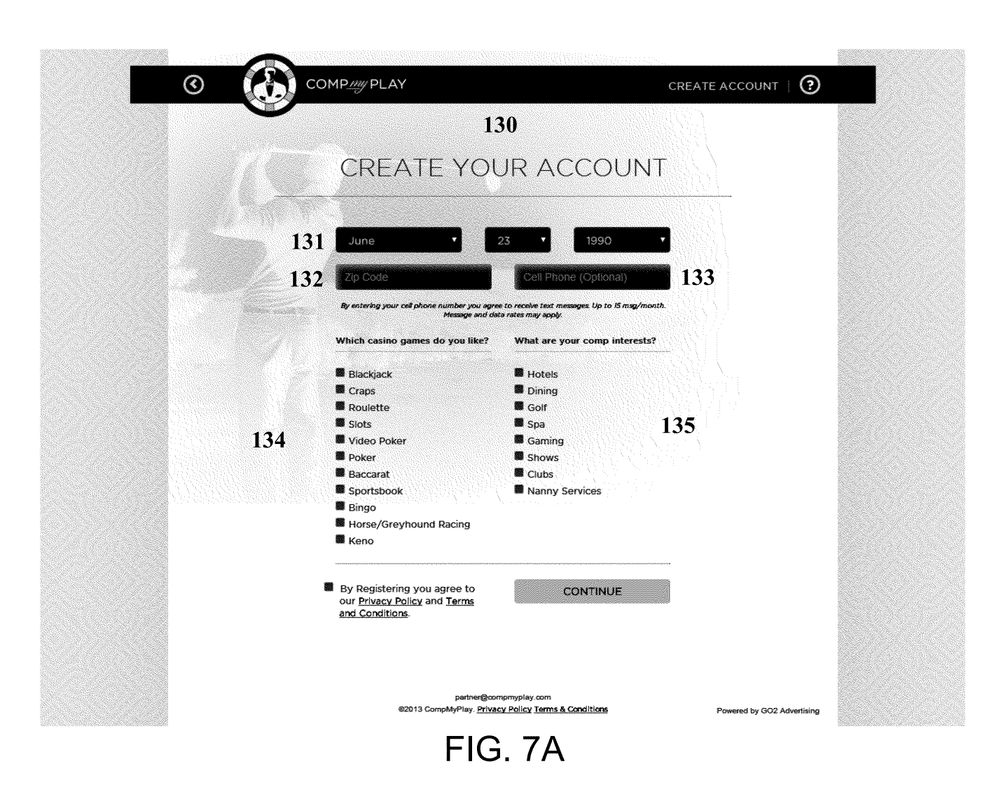

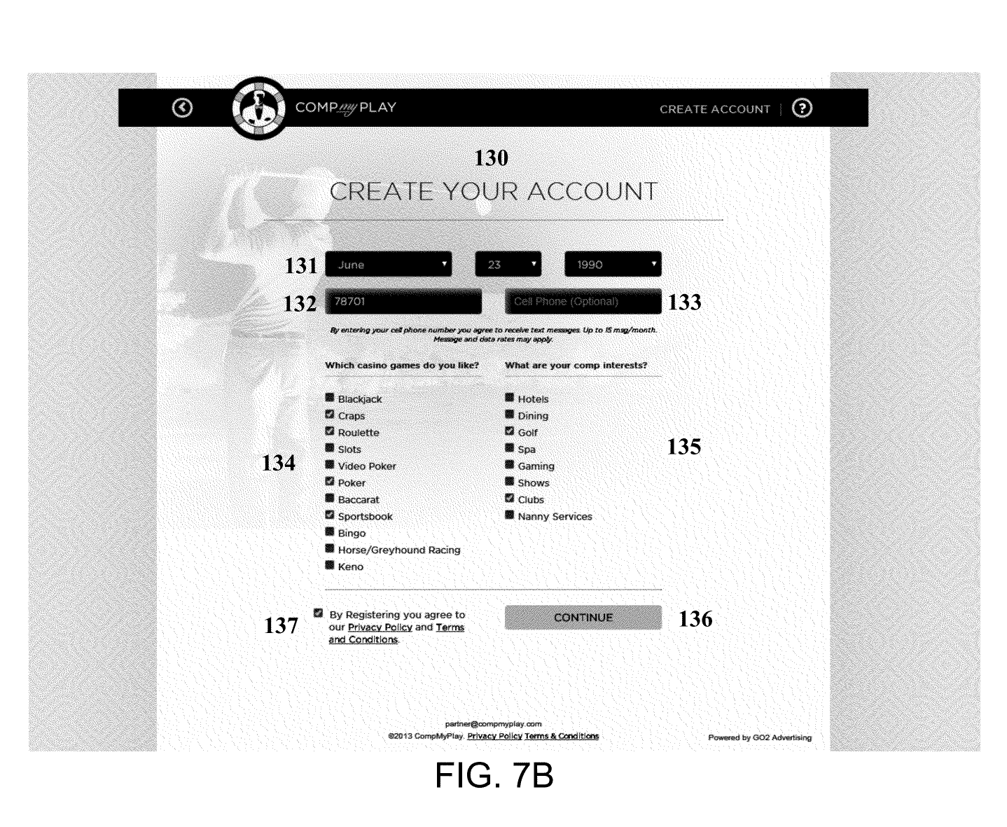

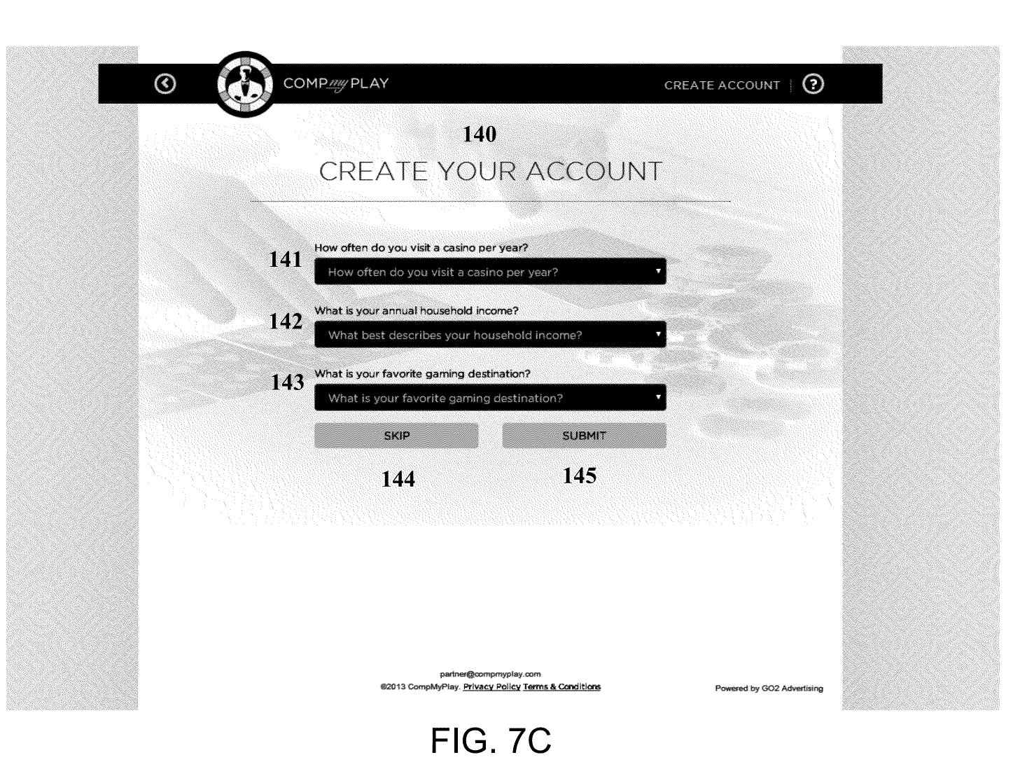

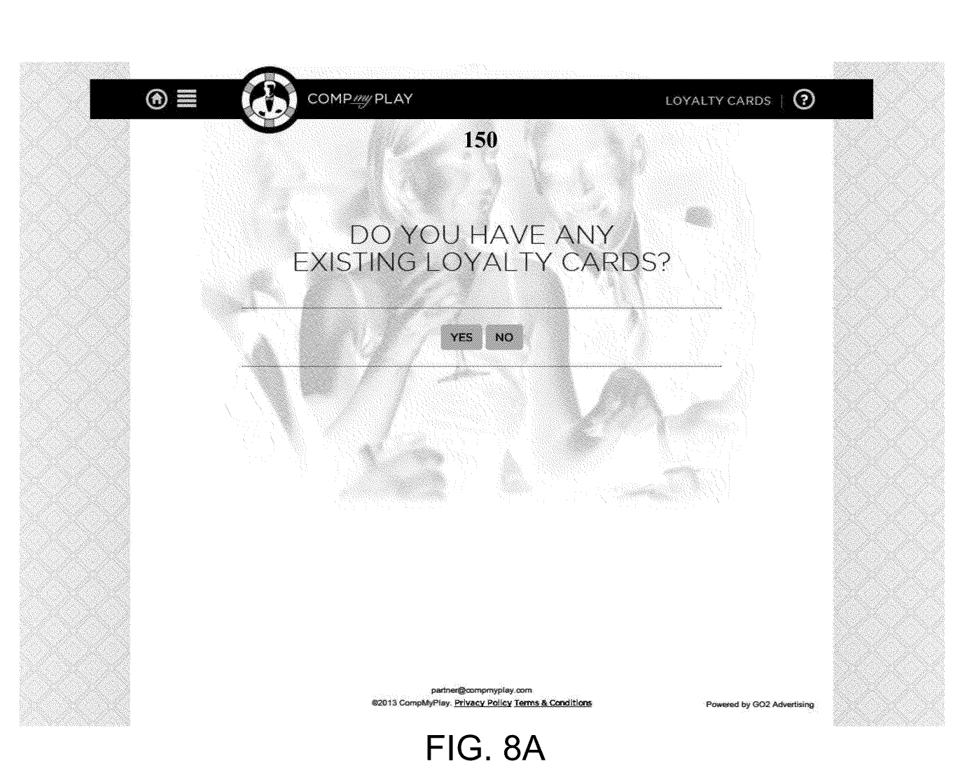

FIG. 7A depicts a screen image from an electronic device 30 depicting the first create account page 130 for the comp allotting application in accordance with one embodiment. Once the “SIGN UP” icon is chosen by a user, the display 58 may display the create profile page 130. The first create profile page 130 may include five main sections that help to collect demographic and behavioral information. This information is used to identify user interests so the CompMyPlay™ content management system may deliver customized comp packages that may be precisely tailored to the user's indicated preferences. The five sections include an age section 131, a zip code section 132, a cell phone section 133, a favorite casino games section 134, and a comp interests section 135. The age, zip code, and cell phone sections 131, 132, and 133 are self explanatory. The age section 131 requires a user to enter the user's age using three separate engageable pull-down menus for the user's month, day, and year of birth while the zip code and cell phone sections 132 and 133 require a user to type in the user's zip code and phone number. Below the zip code and cell phone sections 132 and 133 is the favorite casino games section 134. This section displays a list of casino games may be played in a casino. A user may engage one or more of the fillable boxes located next to the casino games. The casino games include blackjack, craps, roulette, slots, video poker, poker, baccarat, sportsbook, bingo, horse/greyhound racing, and keno. Also found below the zip code and cell phone sections 132 and 133 is the comp interests section 135, wherein a user may share what preset options the user is interested in. These preset options include hotels, dining, golf, spa, gaming, shows, clubs, and nanny services. In other embodiments, the options available to a user may be more or less than the number of options listed above.

As an example, some of the fillable boxes have been engaged and checked on the create profile page 130 found in FIG. 7B. In certain sections such as the favorite casino games section 134 and the comp interests section 135, a user may engage more than one fillable box. Once the user has sufficiently engaged the first create profile page 130, the user may engage the continue icon 136 located at the bottom of the screen. To be taken to a subsequent page, a user must (at some point in the process of filling out the first create profile page 130) engage the fillable box located in the terms & conditions section 137 at some point in time before the user engages the continue icon 136.

FIG. 7C depicts a screen image from an electronic device 30 depicting the second create account page 140 for the comp allotting application in accordance with one embodiment. This page may be viewed after a user engages the continue icon 136 located on the first create account page 130. The second create profile page 140 may include three main sections that help to collect demographic and behavioral information. The three sections include a visit casino section 141, an annual household income section 142, and a favorite destinations section 143. The visit casino section 141 asks a user to disclose how often the user visits a casino during a year. A user may have the options of engaging options in a drop-down menu labeled 0-3, 3-6, 6-9, and 10 or more, each referring to the number of times that a user has visited a casino in a year. The annual household income section 142 is located right below the visit casino section 141. The annual household income section 142 requests a user's total income in their household per year. The user may choose from three options from an engageable drop-down menu: less than $50K, $50-100K, and $100K and above. Below the annual household income section 142 is the favorite destinations section 143, which presents a list of popular casino destinations. A user may engage a destination option located on the engageable pull-down menu found in the favorite destinations section 143. The destinations include (but are not limited to) Las Vegas, Atlantic City, the Southeast, the Midwest, the West Coast, and the East Coast. In other embodiments, the options available to a user may be more or less than the number of options listed above. Once a user engages the proper number of options for each section, the user may engage the submit icon 145. If a user wishes to avoid filling in the above sections, the user may engage the skip icon 144 without filling in the above sections.

Even after a user gives their demographic and behavioral information using the first and/or second create profile pages 130 and 140, the user may go back into their profile at any time and update or change their information. This profile information given by a user also allows casino personnel the ability to hone their marketing outreach and target a very specific subset of patrons.

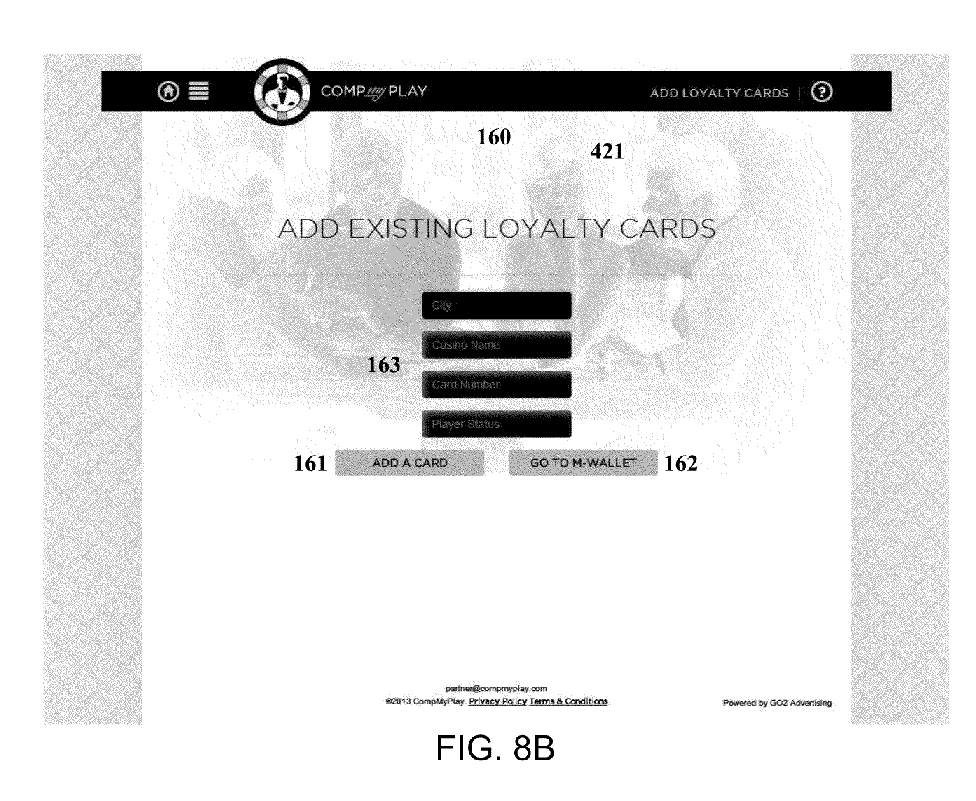

FIG. 8A depicts a screen image from an electronic device 30 depicting the loyalty card section 150 for the comp allotting application in accordance with one embodiment. The loyalty card section 150 requests a user to state if the user has any loyalty cards with casinos. If the user engages the “yes” fillable box, the user will be prompted to enter the city of the casino, casino name, card number, and player status associated with the card in a loyalty card information section 163 found on a subsequent page found in FIG. 8B referred to as the loyalty card information page 160. If a user prefers to provide an image of the card, the user will engage a “Capture card image” icon, subsequently triggering the opening of a camera program existing on the processor-based electronic device 30 utilized by the user. This option is only available on a mobile processor-based electronic device (and is not shown in the page depiction). Once the user fills out the necessary information, the user may engage either the “Add a Card” icon 161 or the “Go to M-Wallet” icon 162. The “Add a Card” icon 161 may add the card to the user's profile. The “Go to M-Wallet” icon 162 may take the user to their M-Wallet page (not shown, but may be accessed through the pull-down menu found on the CompMyPlay™ title bar 421 found at the top of the page). An alternative way the loyalty card information page 160 may be accessed is through the pull-down menu found on the CompMyPlay™ title bar 421.

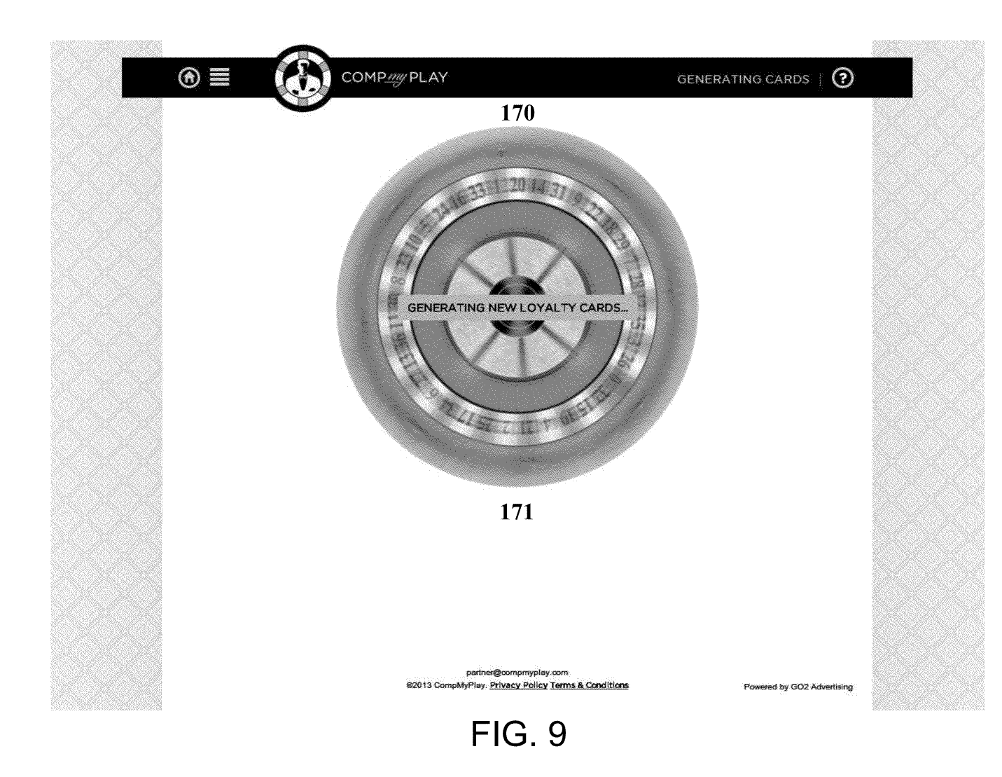

FIG. 9 depicts a screen image from an electronic device 30 depicting the loyalty cards generation page 170 for the comp allotting application in accordance with one embodiment. This page serves as a “loading” screen after a user has completed adding personal information/loyalty cards to the CompMyPlay™ application. A spinning roulette wheel 171 is depicted in the middle of the screen. In the middle of the spinning roulette wheel 171, a statement is shown that states that a user's loyalty cards are being generated. While the loyalty card generation page 170 is displayed, the processor-based electronic device receives computer readable code for each loyalty card (via the computer system 1 and the CompMyPlay™Content Management System 44) and stores the code in the storage device 84 of the electronic device 30.

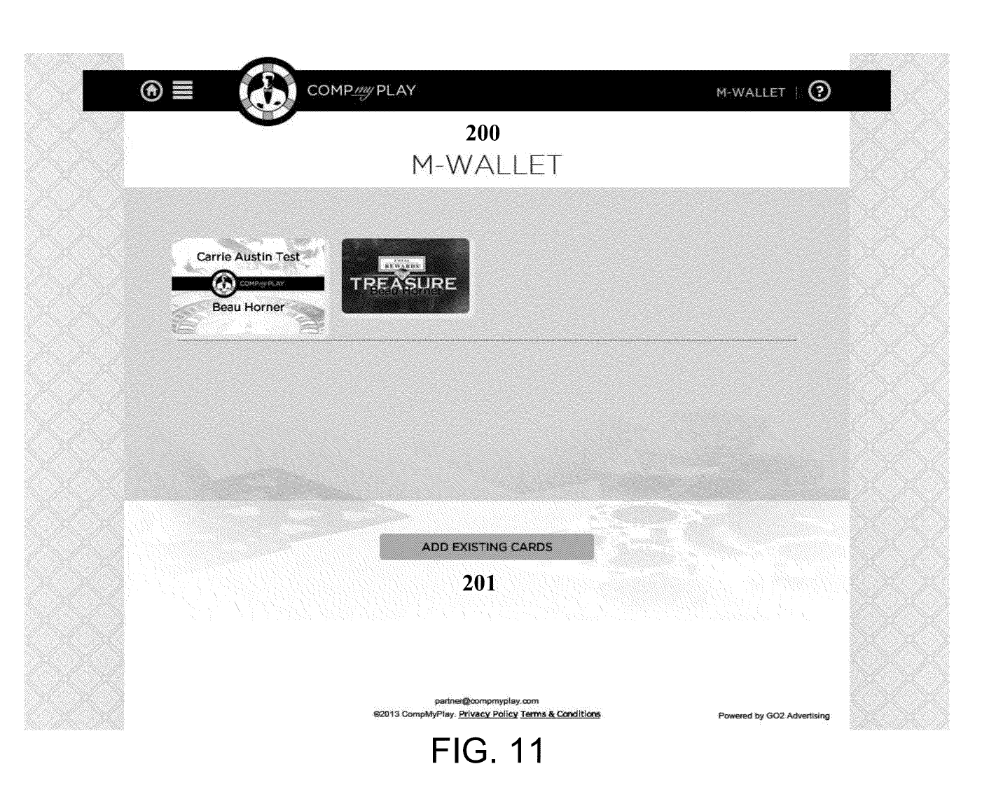

When a user signs up using the create account page 130, the user will automatically be assigned a loyalty card for casinos within a 300-mile radius of the zip code the user had entered on the create account page 130. Computer readable code for each loyalty card will be generated and stored in the storage device 84 of the electronic device 30. When a user accesses the M-Wallet page 200 (FIG. 11), the computer readable code for each loyalty card will be accessed and displayed on the M-Wallet page 200.

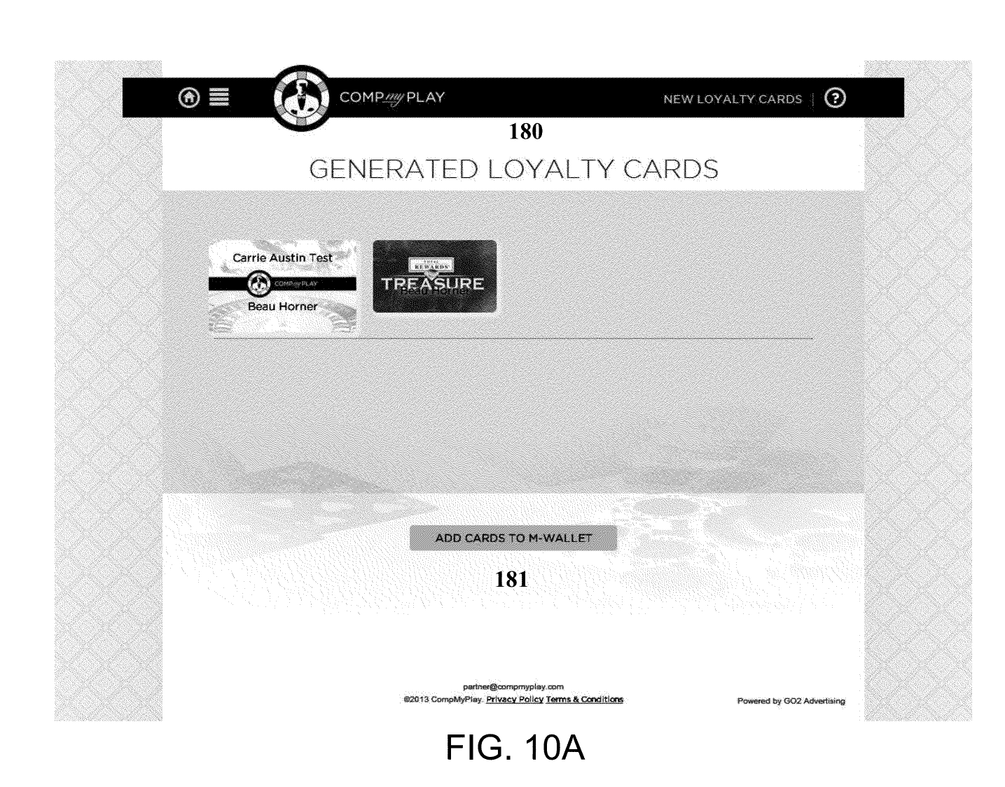

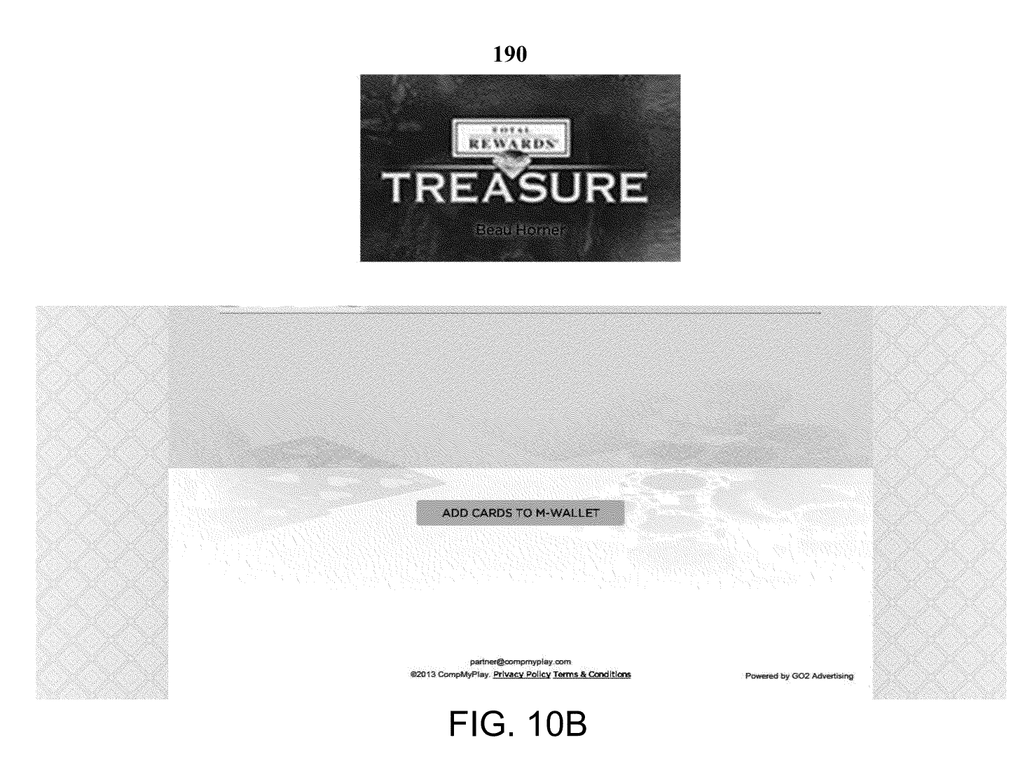

FIG. 10A depicts a screen image from an electronic device 30 depicting the generated loyalty cards page 180 for the comp allotting application in accordance with one embodiment. Generating the loyalty cards involves the utilization of user preferences and one or more of the network communication devices 82 of the electronic device 30, wherein the one or more network communication devices 82 will gather information from casinos within a 300 mile radius of the user's zip code and create computer readable code in the form of a loyalty card. This page displays loyalty cards that may be placed in the M-Wallet (found in FIG. 11), which is a collection of a user's loyalty cards for various casinos. These loyalty cards can be added to the M-Wallet automatically by having a user engage the “Add Cards to M-Wallet” icon 181. Loyalty cards on the M-Wallet page 200 may be hidden from view by the user or by the CompMyPlay™ Content Management System when a user travels to a new location outside of the 300-mile radius of the user's designated zip code.

FIG. 10B depicts a screen image from an electronic device 30 depicting the loyalty card individual card page 190 for the comp allotting application in accordance with one embodiment. When a user engages a single loyalty card on the generated loyalty card page 190, the user will be taken to the loyalty card individual card page 190 that displays the card that was engaged by the user (in the case of FIG. 10B, a Total Rewards: Treasure loyalty card is displayed). The loyalty card displayed on a user's electronic device may show the name of a casino and/or rewards program, as well as the specific card number of the loyalty card. When a loyalty card is displayed on a user's electronic device, the user will be able to use that loyalty card at the casino of the loyalty card. In another embodiment, the loyalty card displayed on the loyalty card individual card page 190 will display the current value of the loyalty card.

FIG. 11 depicts a screen image from an electronic device 30 depicting the M-Wallet page 200 for the comp allotting application in accordance with one embodiment. The M-Wallet, or Mobile Wallet, may be accessed using the engageable drop down menu found on the CompMyPlay™ title bar 421. The purpose of the M-Wallet is to store all loyalty cards pertinent to a user. If a user needs to add a loyalty card, the user may engage the “Add Existing Cards” icon 201, wherein the user will be led to a screen where the user may enter information about the card on a page similar to that found in FIG. 8B. If a user is engaging the application on a mobile electronic device, the user may have the option to take a picture of an already existent loyalty card, wherein the application may recognize the card and upload pertinent information from the card. This is done using the Content Management System 44. The Content Management System 44 contains loyalty card images and information for a vast number of casinos. When a user takes a picture of a loyalty card, the application accesses the Content Management System 44 through a network connection and correlates the picture taken with what is available with the database. The matched data is sent back to the device on which the user is accessing the application and the loyalty card is added to the user's M-Wallet.

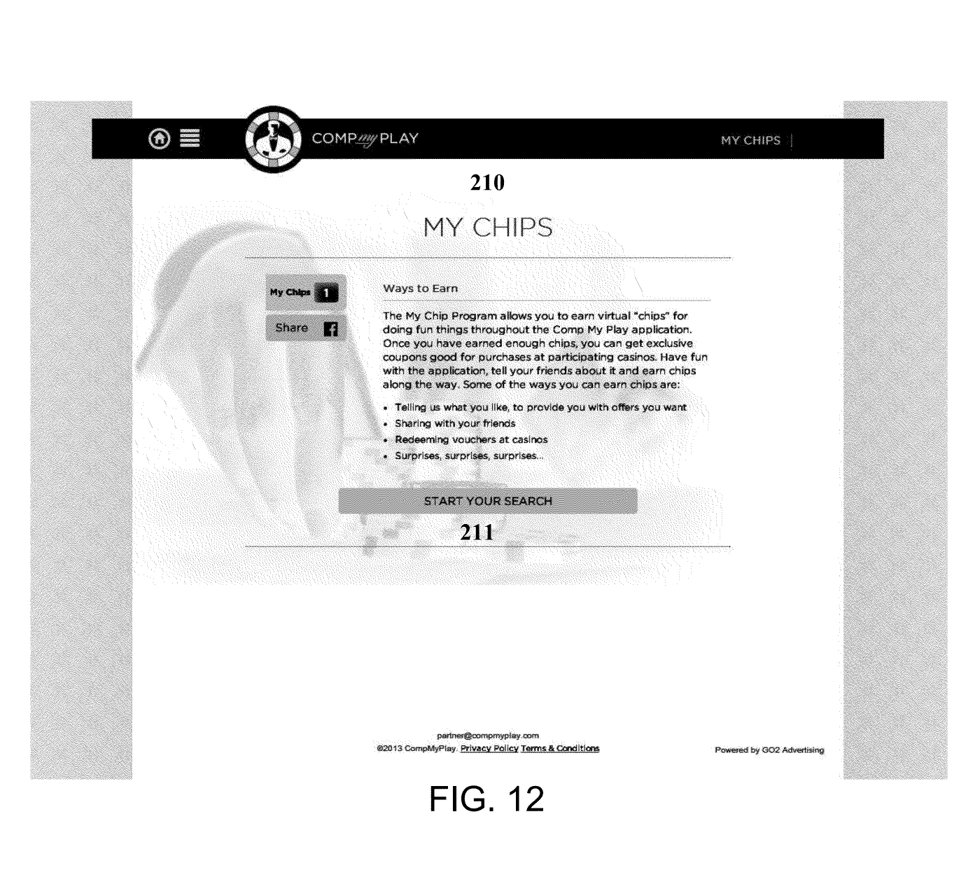

FIG. 12 depicts a screen image from an electronic device 30 depicting the “My Chips” page 210 for the comp allotting application in accordance with one embodiment. Using the “My Chips” page 210, a user may earn chips that may be traded in for coupons for goods that may be purchased at certain casinos. The chips may be traded-in (in sets of 25) for a coupon. These chips may be earned by providing preferences to the CompMyPlay™ application, sharing information about CompMyPlay™ with friends (through Facebook®, a registered trademark of Facebook, Inc., etc.), redeeming vouchers at casinos, etc. Located at the bottom of the “My Chips” page 210 is the engageable “Start Your Search” icon 211 that may allow a user to search for comps that match their preferences.

In another embodiment, sets of chips other than sets of 25 may be traded-in for coupons.

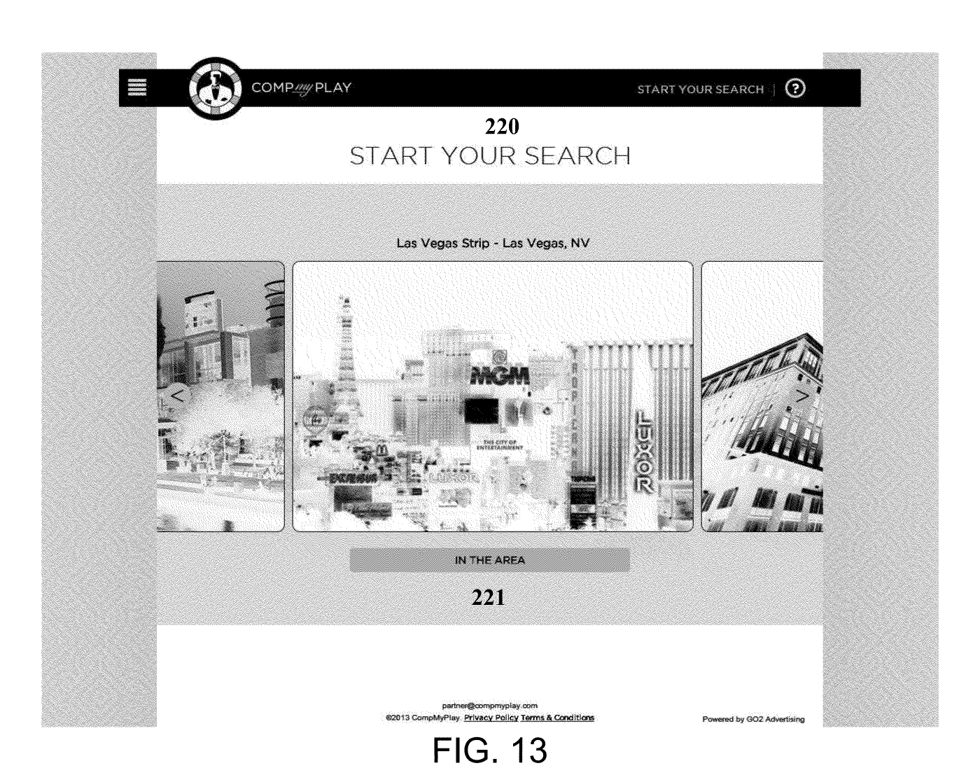

FIG. 13 depicts a screen image from an electronic device 30 depicting the start search page 220 for the comp allotting application in accordance with one embodiment. The start search page 220 may be viewed once a user either signs in on the log-in page 110 and selects the start search page 220 from the drop-down menu found on the CompMyPlay™ title bar 421 or navigates away from the “My Chips” page 210 using the engageable “Start Your Search” icon 211. The start search page 220 displays an “In the Area” engageable icon 221 located below a slideshow of pictures of casinos.

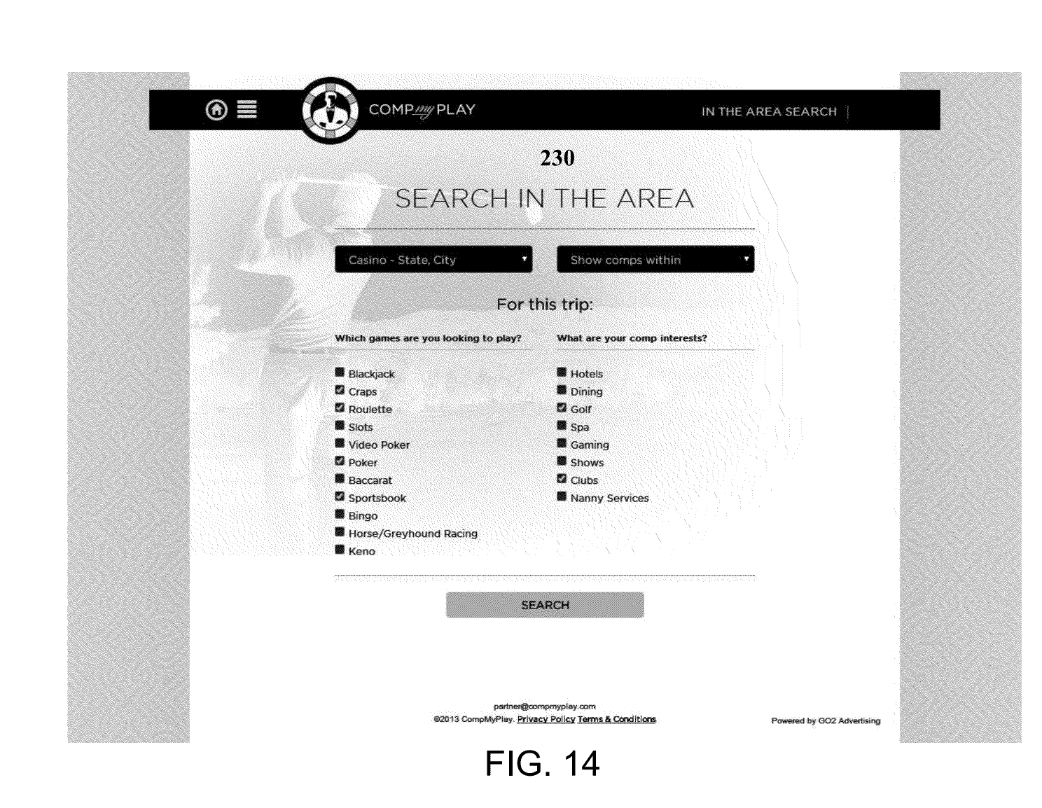

When a user engages the “In the Area” icon 221, the user will be taken to the “In the Area” page 230, as shown in FIG. 14. It is here that the user may enter custom user preferences relating to casinos found in a specific proximity. The information entered on this page may be sent to the CompMyPlay™ Complex Relational Database 41. Once the Complex Relational Database 41 receives the user preferences, the Complex Relational Database 41 may access the computing systems 1 of the casinos partnered with CompMyPlay™ in order to find comps that correlate with the user preferences. The user may utilize engageable pull-down menus located below the user preference labels “Casino—State, City” and “Show comps within”. For the preference label referring to types of games, the user may engage clickable boxes located next to a specific type of gambling, such as casino gaming, online gaming, racetrack gambling, or all of the preferences (will already be filled out from previously entered preferences). For the preference label referring to comp interests, the user may engage clickable boxes located next to specific genres of comps, such as dining, golf, gaming, and shows (again, will already be filled out from previously entered preferences). In order to complete a search for comps located a certain distance away from the user, the Content Management System 44 may receive data sent from one or more of the network communication devices 82 of the electronic device 30 that shows the exact location of the user. Once a user has chosen specific preferences, the user may engage a search icon at the bottom of the page. In further embodiments, the user may choose from more or less than four types of gambling preferences and more or less than three specific distance preferences. Once a user has engaged the search icon found at the bottom of the “In the Area” page 230, the user may be led to the generation page 210 (FIG. 14).

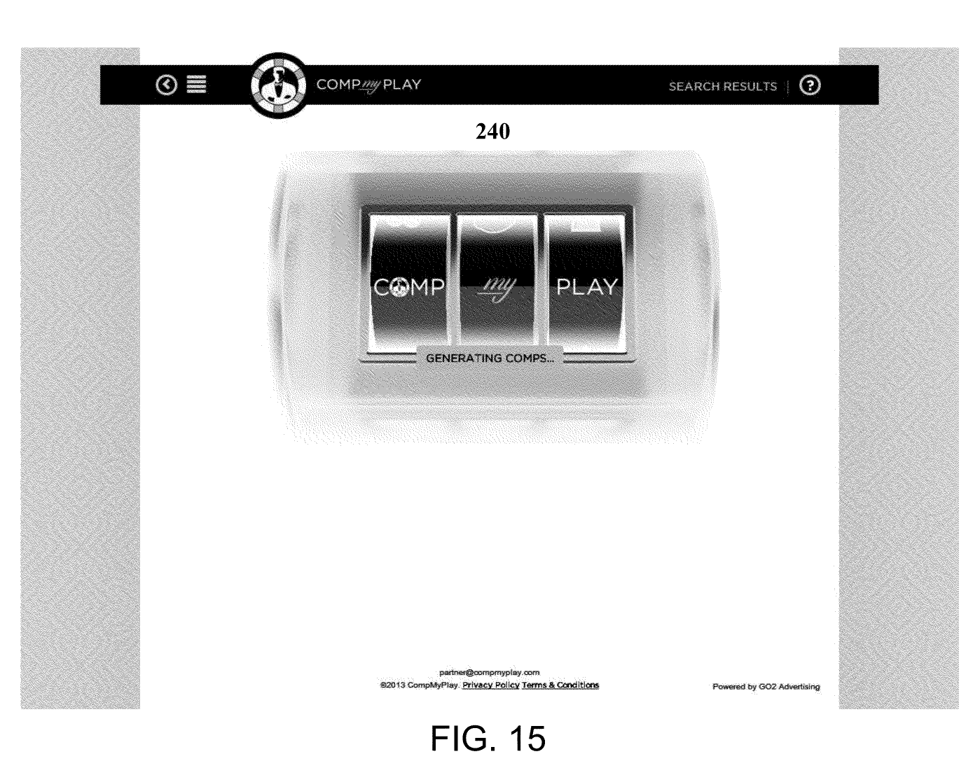

FIG. 15 depicts a screen image from an electronic device 30 depicting the generation page 240 for the comp allotting application in accordance with one embodiment. This page serves as a “loading” screen after a user has engaged a search icon found at the bottom of the “In the Area” page 230. A slot machine located in the middle of the page is shown with three reels spinning during the load time. Once the load time is complete, the reels will stop with the terms “COMP”, “MY”, and “PLAY” located in the middle of the slot machine once the load time is complete. During the loading time, the user's electronic device 30 may connect through a wireless network to the Complex Relational Database 41, wherein the Complex Relational Database 41 may connect to computing systems 1 of casinos signed up with CompMyPlay™ and that have comps that are within the bounds of the preferences entered by the user on the “In the Area” page 230. The Complex Relational Database 41 may receive (from the computing systems 1) comps that are within the bounds of the preferences entered by the user on the “In the Area” page 230 in the form of computer readable code. This computer readable code is then sent back to the user's electronic device 30, wherein the user may view the comps found by the Complex Relational Database 41. In further embodiments, the spinning of the reels may stop more than once during a loading period, with the reels displaying a number of different symbols and/or terms relative to CompMyPlay™ or casinos.

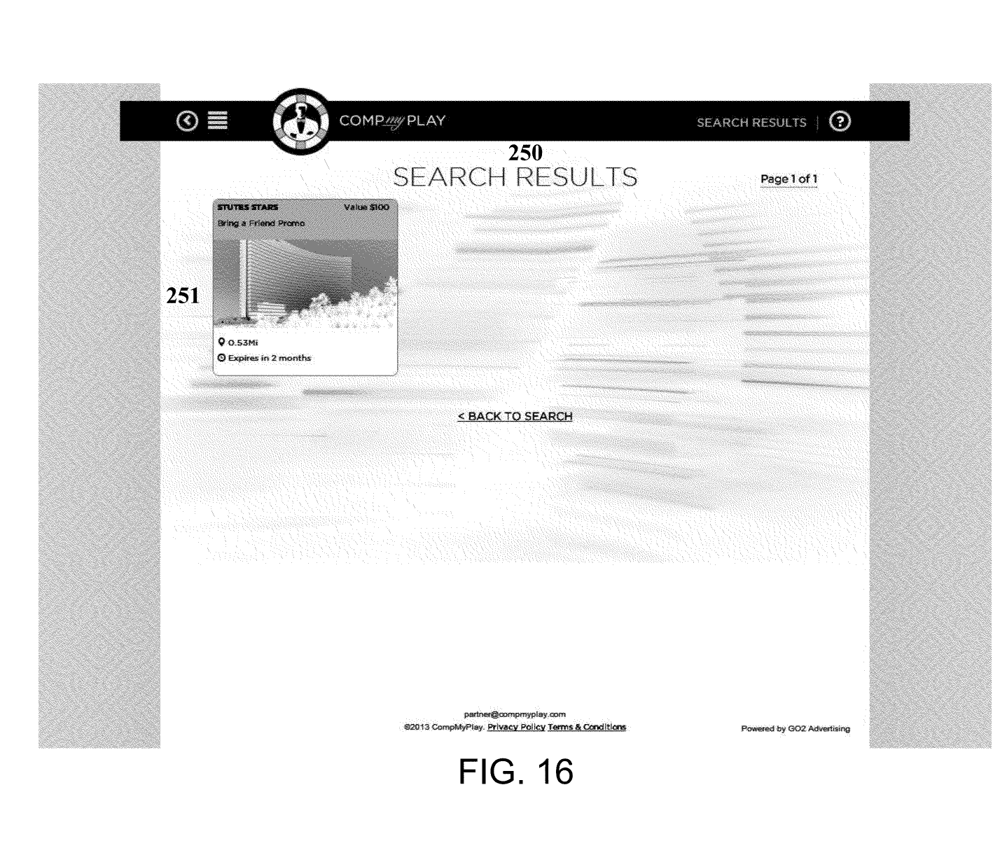

FIG. 16 depicts a screen image from an electronic device 30 depicting the “In the Area” comp results page 250 for the comp allotting application in accordance with one embodiment. This page displays comp results when a user inputs preferences on the “In the Area” page 230. The code for these results are found by the CompMyPlay™ Complex Relational Database 41, sent to the electronic device 30 via a wireless network, and received by one or more of the network communication devices 46. Each comp result 251 is displayed and separated by casino and shows the name of the casino, the location of the casino in relation to the user, the amount of time until the comp expires, the total value of the comp, and any promotional offers included with each comp result 251. In further embodiments, each comp result may also show the contact details of each casino.

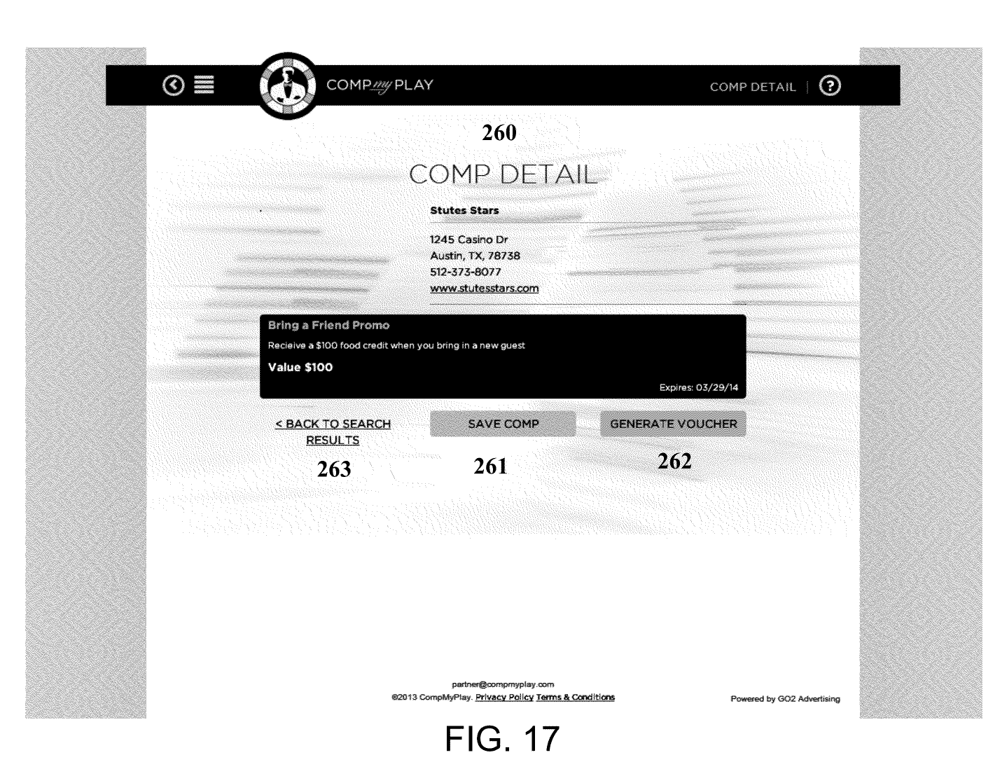

FIG. 17 depicts a screen image from an electronic device 30 depicting the “In the Area” single comp page 260 for the comp allotting application in accordance with one embodiment. When a user engages a single comp offer on the “In the Area” comp results page 250, the user will be taken to the “In the Area” single comp page 260 that displays a comp offer 251 that was engaged by the user (in the case of FIG. 17, a Stutes Stars comp package is displayed). The comp offer displayed on a user's electronic device 30 shows the name and contact information of a casino, as well as the comp offer and value of the comp offer. When a comp offer is displayed on a user's electronic device 30, the user will be able to go back to the comp search results, save the comp offer 251, or generate the voucher of the comp offer 251 using the save comp icon 261, generate voucher icon 262, or the back to search results icon 263 found at the bottom of the page. If a user engages the save comp icon 261, the computer readable code for the comp may be stored on the storage device 84 of the electronic device 30.

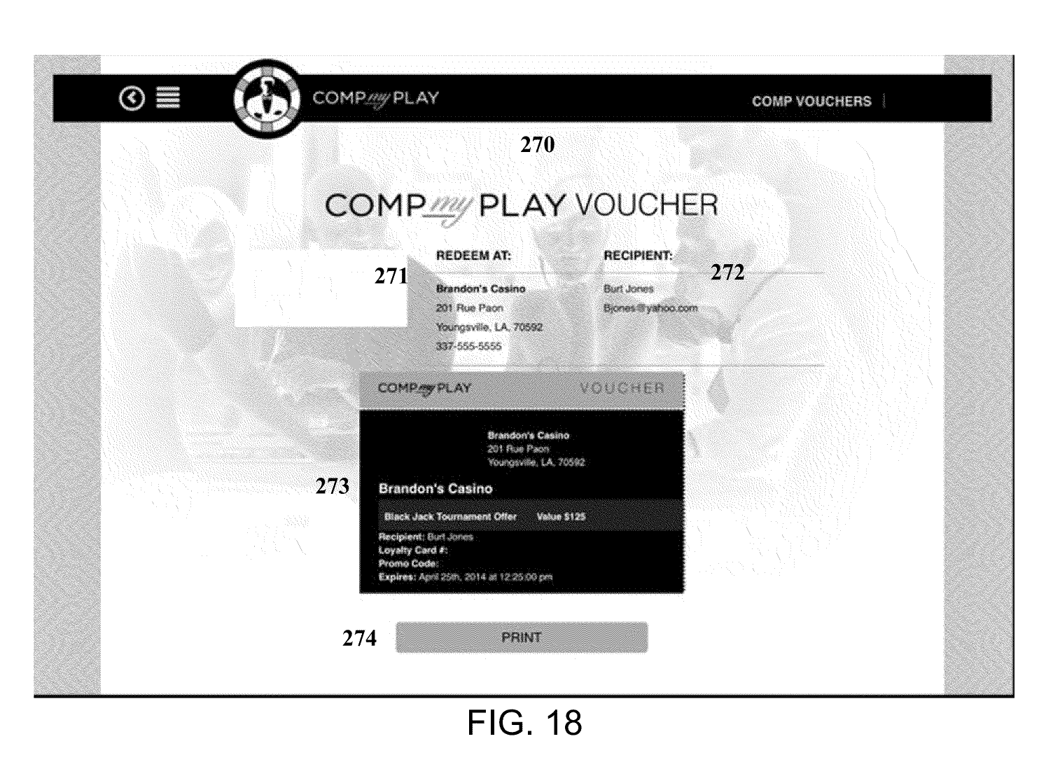

FIG. 18 depicts a screen image from an electronic device 30 depicting the generated voucher page 270 for the comp allotting application in accordance with one embodiment. This page displays a voucher for the accepted comp offer, as well as a CompMyPlay™ code that must be provided when a user books a room at the hotel of the casino with which the voucher corresponds. Found on the generated voucher page is a redemption section 271, where a user may find location and contact information of the casino at which the voucher may be redeemed. Adjacent the redemption section is the recipient section 272 that shows the recipient of the voucher. Below the redemption section 271 and recipient section 272 is the voucher section 273 that displays the actual voucher. The voucher may be printed by a user engaging the print icon 274 found at the bottom of the page.

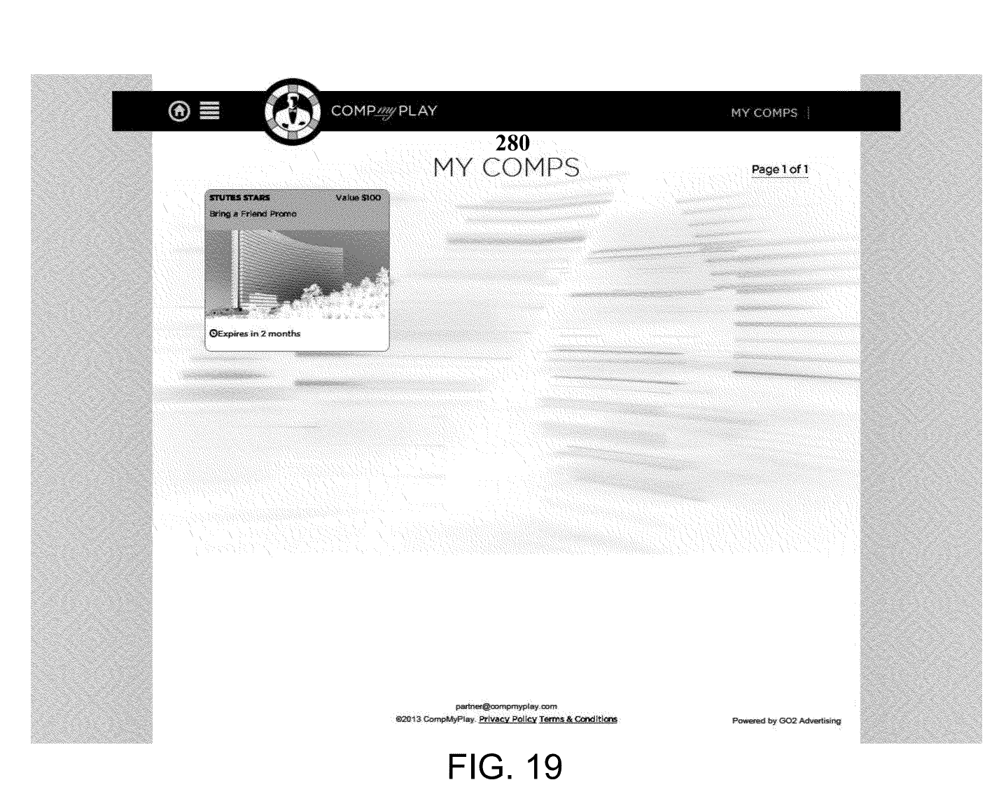

FIG. 19 depicts a screen image from an electronic device 30 depicting the my comps page 280 for the comp allotting application in accordance with one embodiment. Once a user engages the save comp icon 261 on the “In the Area” single comp page 260, the user may view the saved comp in their comp folder by engaging the “MY COMPS” icon on the pull down menu found on the CompMyPlay™ title bar 421 on one or more pages of the application. Each comp result is displayed and separated by casino and shows the name of the casino, the location of the casino in relation to the user, the amount of time until the comp expires (or the date window in which the comp may be used), the total value of the comp, and any promotional offer included with each comp.

The accepted comp folder page may further include a CompMyPlay™ title bar 421 located at the top of the screen. Once engaged by a user, the user is shown one or more page option icons which they may engage in order to be taken to another page. For example, if the user engages the “M-Wallet” icon, the user may be taken to the M-Wallet page 200. In alternate embodiments, one or more of the mentioned pages that may exist on an electronic device may include an engageable tab/pull down menu icon. On one or more of the pages, the CompMyPlay™ title bar 421 may exist anywhere on the pages.

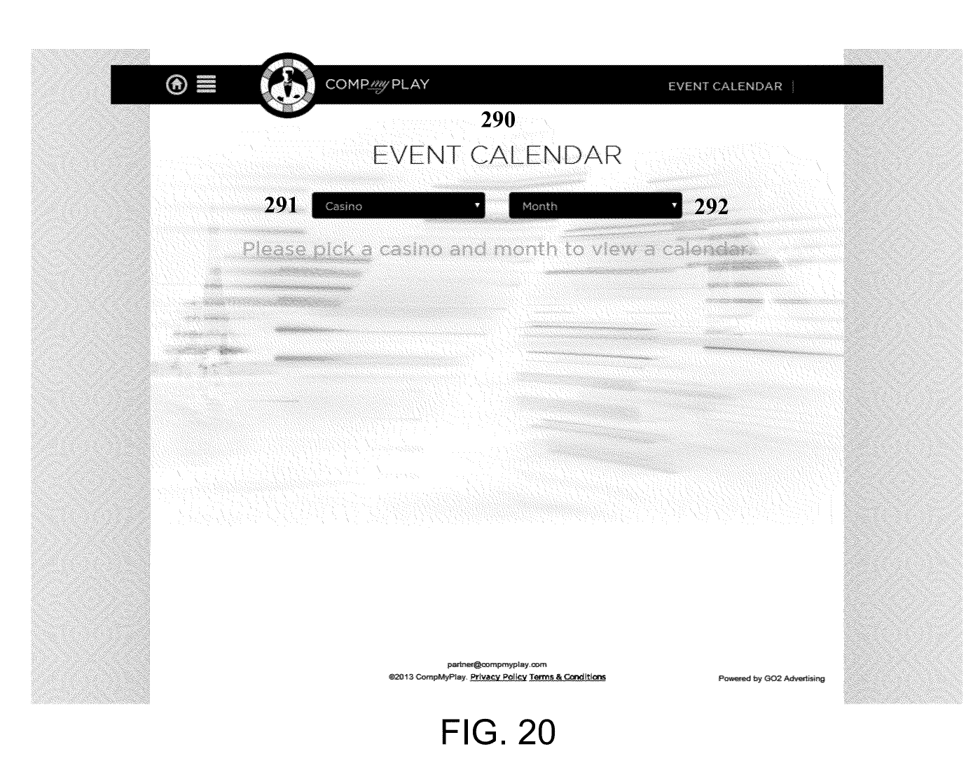

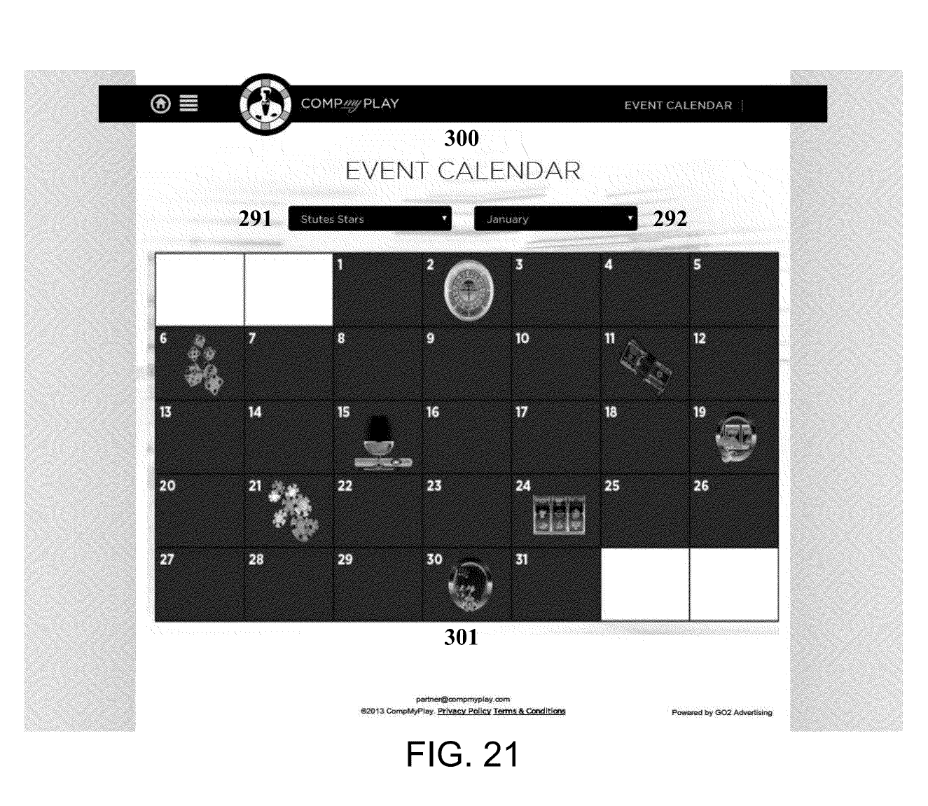

FIG. 20 depicts a screen image from an electronic device 30 depicting the event calendar home page 290 for the comp allotting application in accordance with one embodiment. If a user happens to engage the “EVENTS CALENDAR” option on the CompMyPlay™ title bar 421 located on one or more pages, the electronic device 30 will display the screen image depicting the event calendar home page 290. This page may display one or more separate advertisements depicting various casinos. Above the advertisements is a casino pull down menu 291 and month pull down menu 292 that, when engaged by a user, displays drop down menus of various casinos. Once a user engages a casino and month from the drop down menus 291, 292, the user may then view a calendar of the events that are going to take place during the month chosen. For example, the January events for Stutes Stars are depicted in FIG. 21, referred to as the event calendar display page 300, wherein a calendar 301 is depicted below the drop down menus 291, 292.

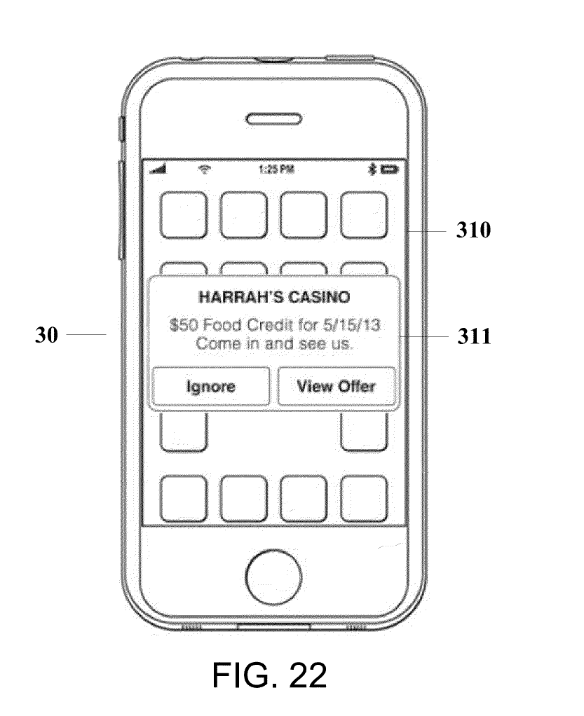

FIG. 22 depicts an electronic device 30 depicting a push offer screen image 310 for the comp allotting application in accordance with one embodiment. Using the network communication device 84, the user may receive from a casino a comp push notification 311 that alerts a user of a comp that may be used at the casino from which the comp was sent. The distribution of these comp push notifications 311 is controlled and created directly by the casino. Once the comp push notification 311 is completed, the casino may set the parameters for when and where the comp will be sent out. Users may “pause” push offers from being pushed to their phone using the settings in their electronic devices 30.

II. Casino Administrator Experience

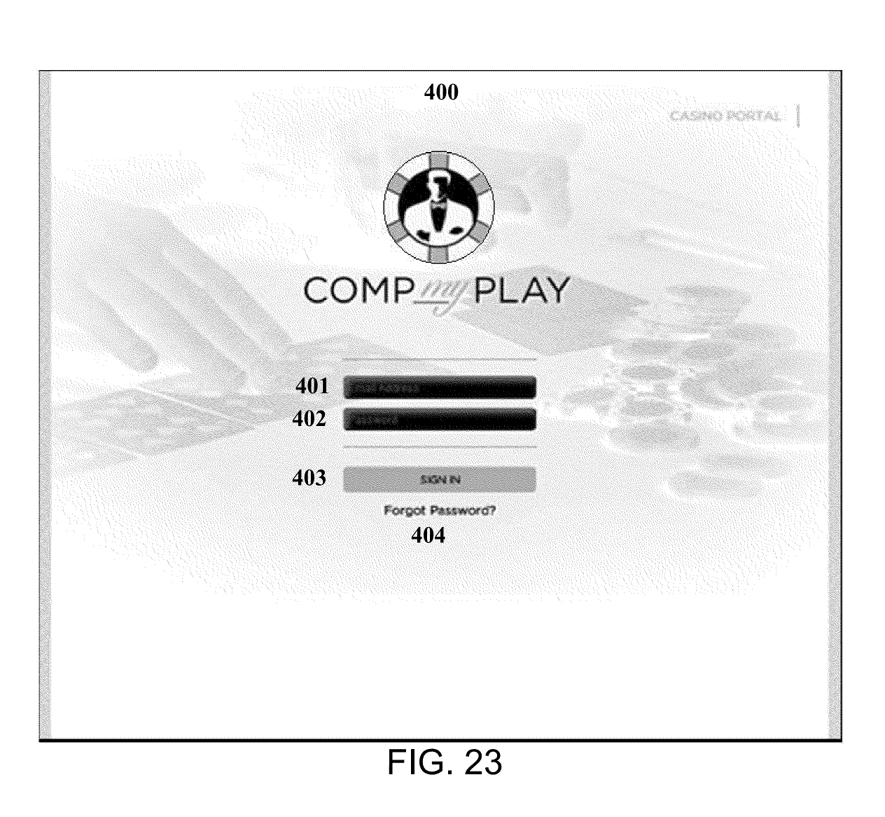

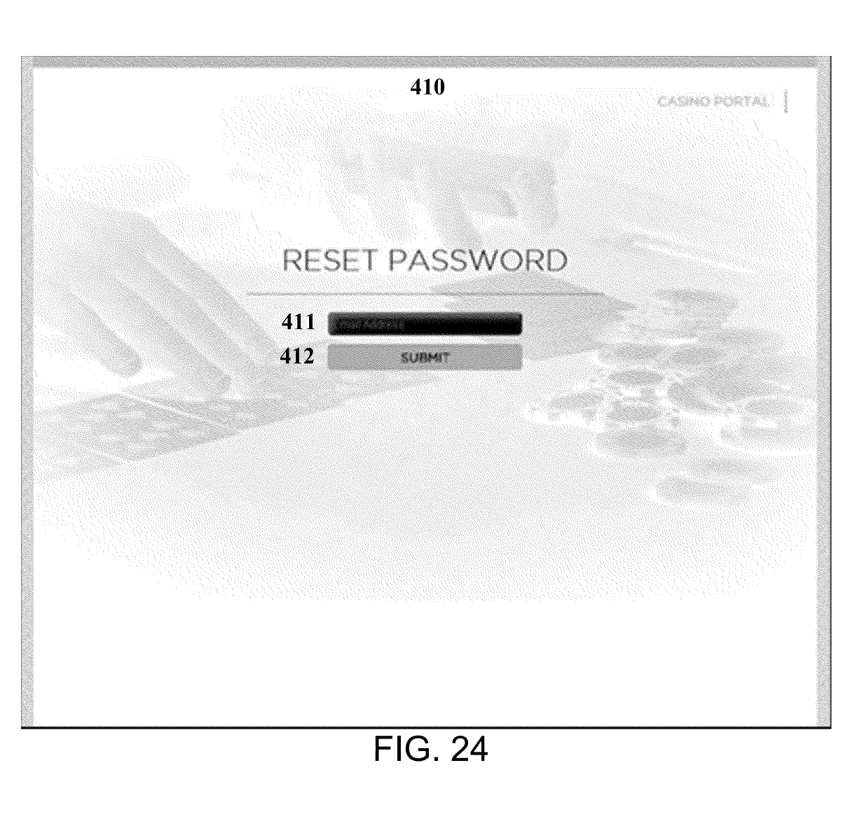

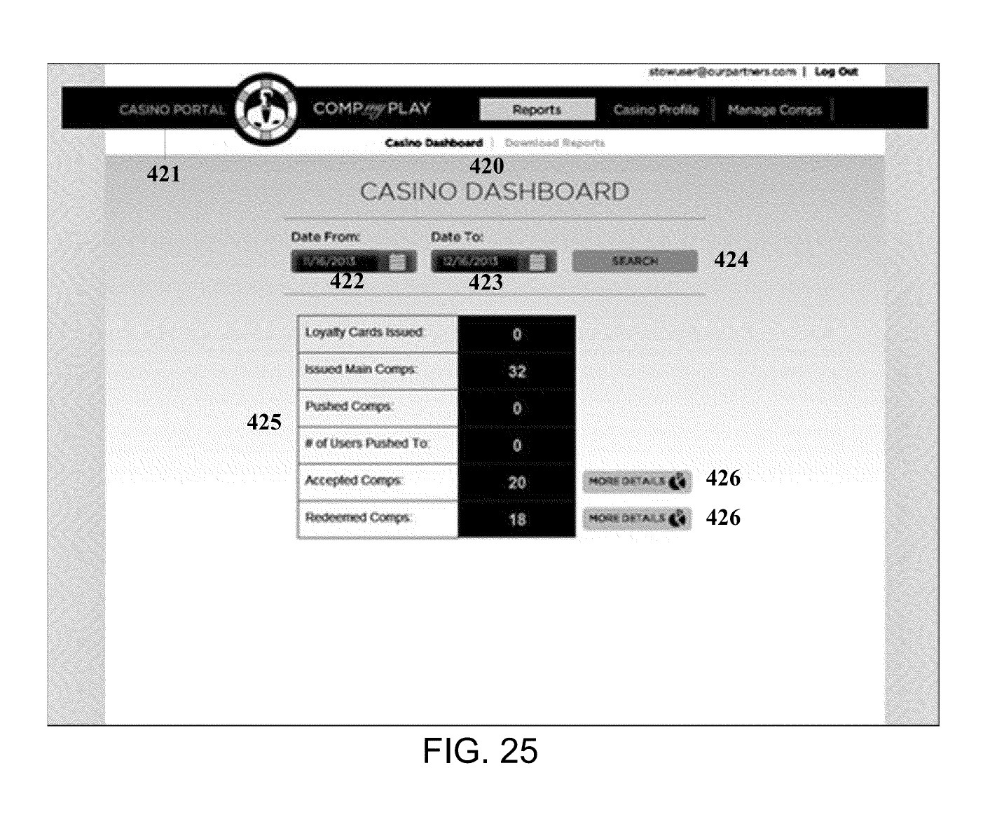

FIG. 23 depicts a screen image from an electronic device 30 depicting the casino administration log-in page 400 for the comp allotting application in accordance with one embodiment. This log-in page 400 is designed for casino administrators to log into the CompMyPlay™ network. The middle of the screen image depicts engageable fill-in sections 401 and 402, wherein a casino administrator may input an email address and password exclusive to a casino account. Once the fill-in sections 401 and 402 are properly filled out, a casino administrator may engage the sign in icon 403 and be led away from the screen image. If a casino administrator has forgotten the password used to login, the casino administrator may engage the forgot password icon 404, wherein the casino administrator may be taken to the reset password page 410 found in FIG. 24. A casino administrator may then enter an email address into the email section 411 that may be accessed by the casino administrator. Once the submit icon 412 is engaged, an email will be sent to the email address entered in the email section 411 to allow a casino administrator to change the password.

FIG. 25 depicts a screen image from an electronic device 30 depicting the casino dashboard page 420 for the comp allotting application in accordance with one embodiment. The casino dashboard page 420 may be accessed by first engaging the reports tab on the CompMyPlay™ title bar 421 and subsequently engaging the casino dashboard tab under the reports tab. A casino administrator may utilize the date engageable icons 422, 423 in order to input a timeframe. Once the timeframe is input and the search icon 424 is engaged, a comps chart 425 will appear on the casino dashboard page 420 that displays statistics such as, but not limited to, loyalty cards issued, issued main comps, pushed comps, number of users pushed to, accepted comps, and redeemed comps.

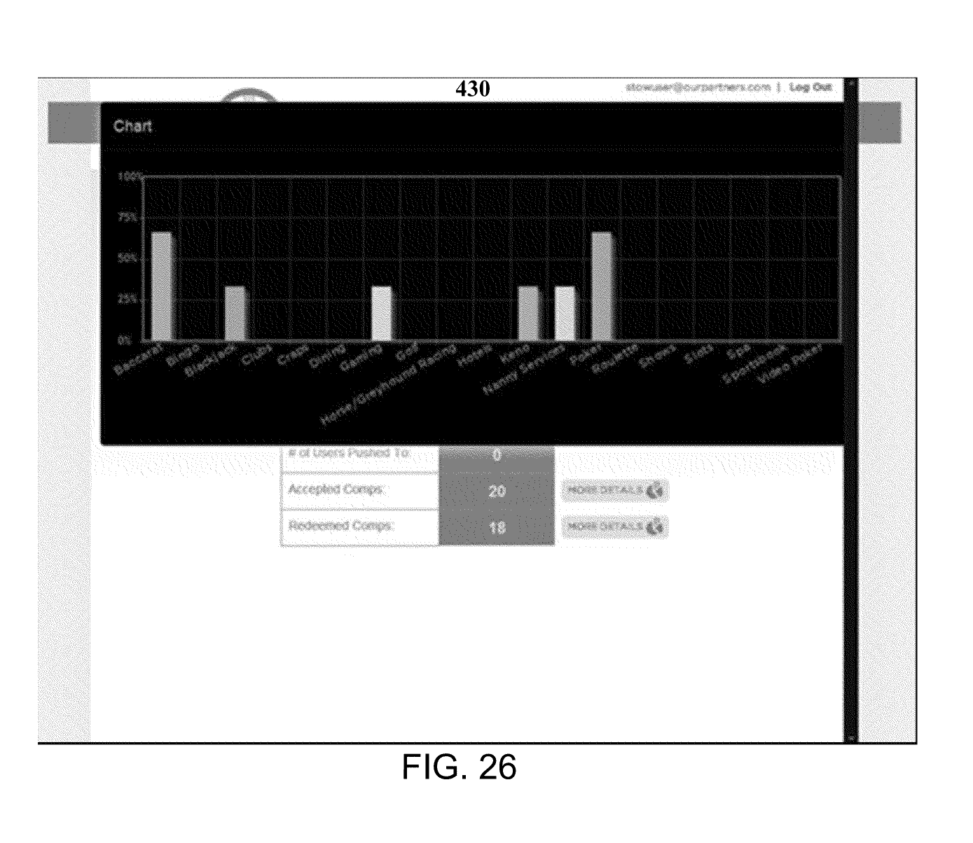

Further details for the accepted comps and redeemed comps may be shown by engaging the more details icon 426 next to one or more statistics categories. When a casino administrator engages a more details icon 426, a screen image of a statistics chart will appear over part of the casino dashboard page 420; this page is referred to as the comps statistics page 430 found in FIG. 26. The chart may display a graph depicting statistics for a specific comp category. For example, the graph displayed in FIG. 26 depicts the percentage of specific comps that have been accepted from a specific casino.

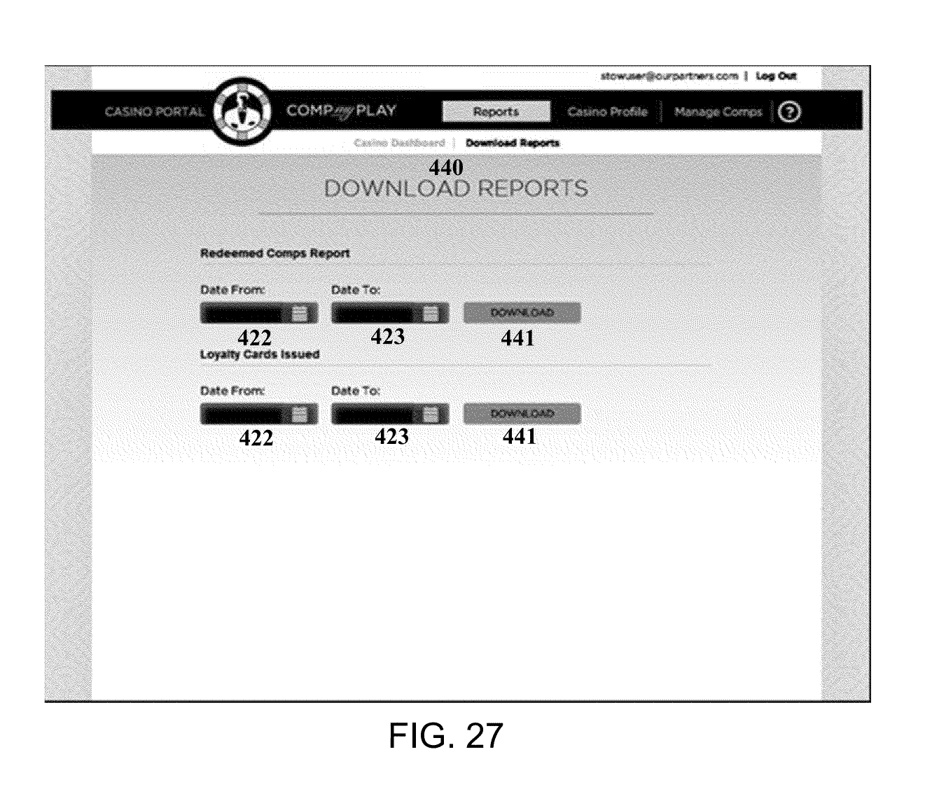

FIG. 27 depicts a screen image from an electronic device 30 depicting the reports download page 440 for the comp allotting application in accordance with one embodiment. When a casino administrator engages the download reports page tab located adjacent to the casino dashboard tab, a report related to either redeemed comps or loyalty cards may be downloaded. The specificity of the reports may be related to the timeframe that a casino administrator inputs into one or more sets of date engageable icons 422, 423. A Casino administrator may download the one or more reports by engaging a download icon 441 located adjacent to one or more sets of date engageable icons 422, 423.

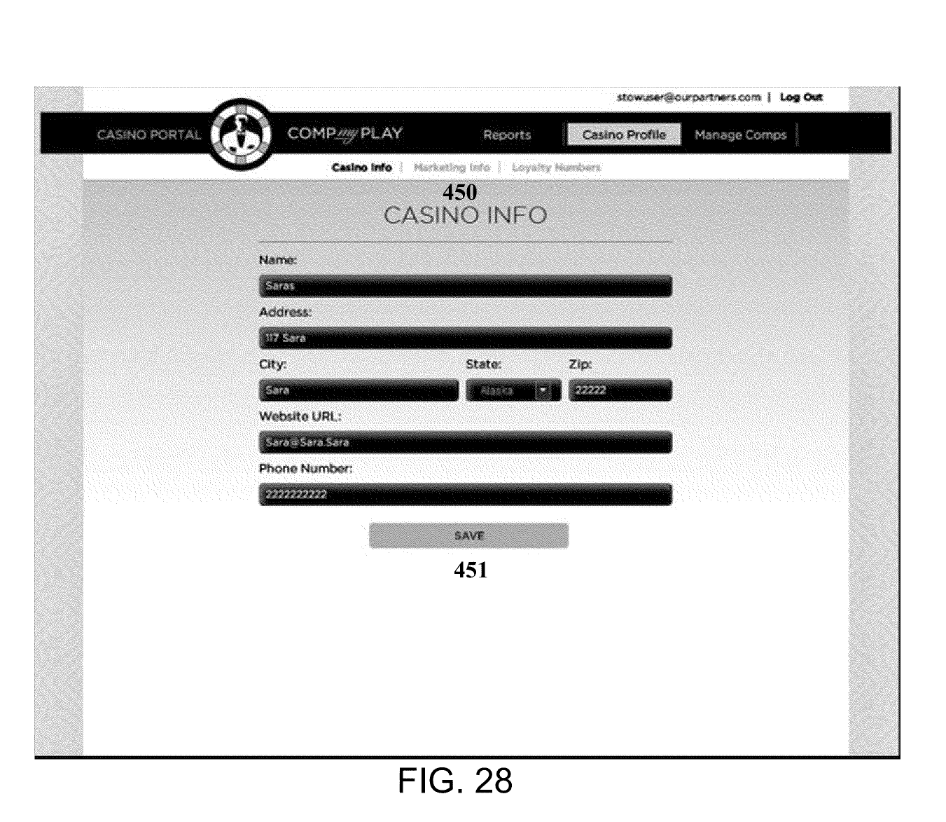

FIG. 28 depicts a screen image from an electronic device 30 depicting the casino info page 450 for the comp allotting application in accordance with one embodiment. When a casino administrator engages the casino profile tab found in the CompMyPlay™ title bar 421, the administrator may be taken to the casino info page 450. It is here that the casino administrator is able to enter casino information into the page that is specific to that casino. The information may include, but is not limited to the name of the casino, the address of the casino (including street, city, state, and zip code), the website URL of the casino, and the phone number of the casino. The information may then be stored on the storage 84 of the electronic device 30 being utilized by engaging the save icon 451.

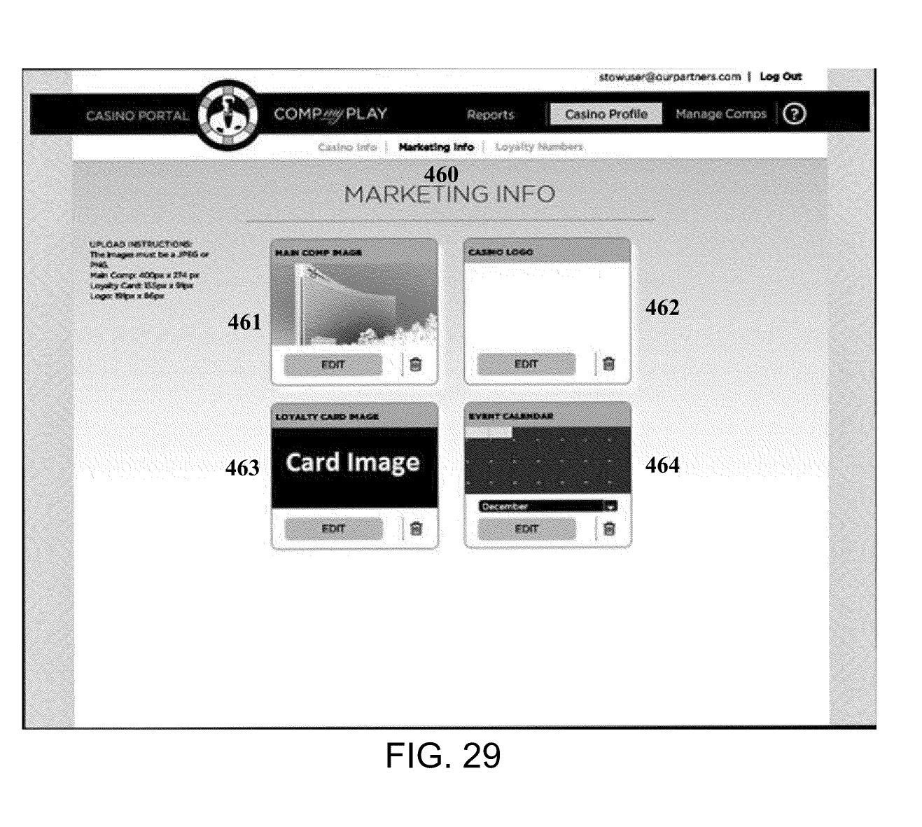

FIG. 29 depicts a screen image from an electronic device 30 depicting the marketing info page 460 for the comp allotting application in accordance with one embodiment. When a casino administrator engages the marketing info tab found in the CompMyPlay™ title bar 421, the administrator is taken to the marketing info page 460. Images may be uploaded to three separate image sections: the main comp image section 461, the casino logo image section 462, and the loyalty card image section 463. Events may also be added under certain months in the event calendar section 464. The images and/or events may be stored on the storage 84 of the electronic device 30. Any uploaded image or event may also be deleted using a trashcan icon located at the bottom right of each section found on the marketing info page 460.

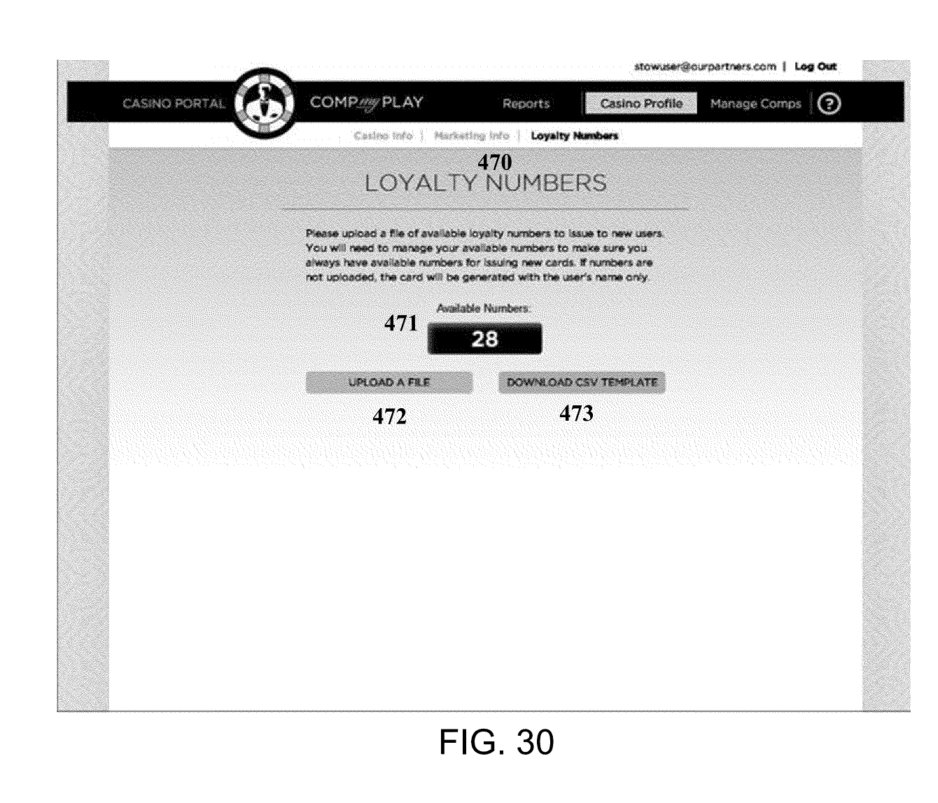

FIG. 30 depicts a screen image from an electronic device 30 depicting the loyalty numbers page 470 for the comp allotting application in accordance with one embodiment. When a casino administrator engages the loyalty numbers tab found in the CompMyPlay™ title bar 421, the administrator may be taken to the loyalty numbers page 470. A casino administrator may be shown the amount of available loyalty numbers in an available numbers section 471. The loyalty numbers may refer to the numbers that are found on loyalty cards that may be given to patrons of a casino. The administrator may add a loyalty number by engaging the upload a file icon 472 and uploading a .csv file to the interface. The administrator may also download a .csv template by engaging the download .csv template icon 473 found in the middle of the loyalty numbers page 470.

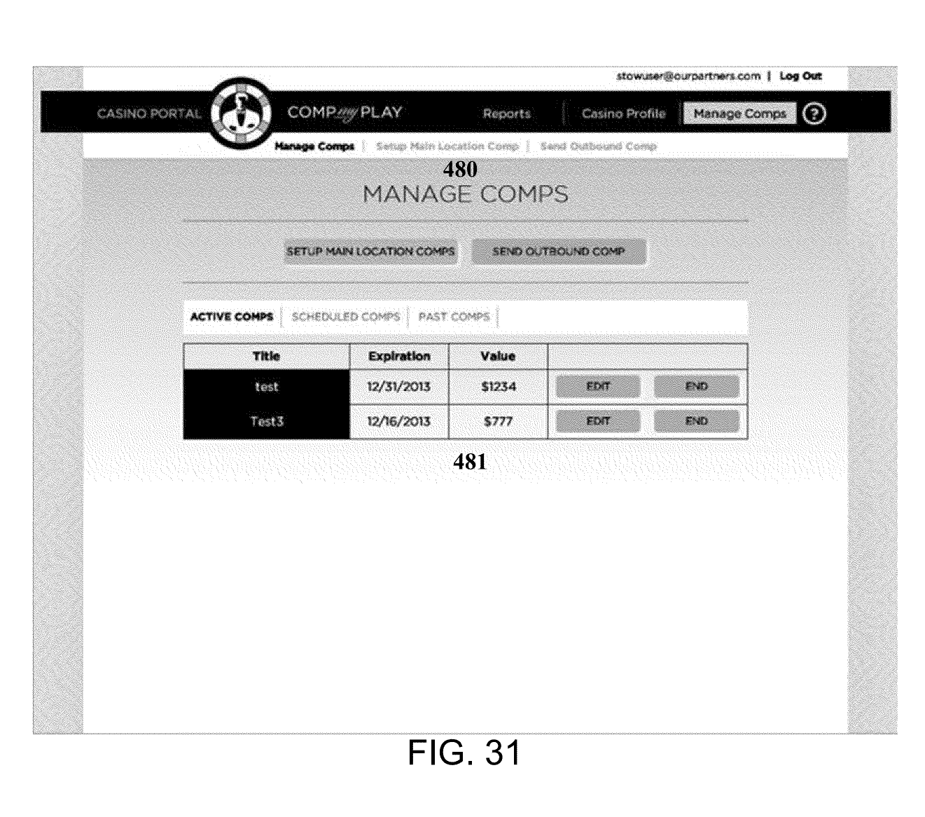

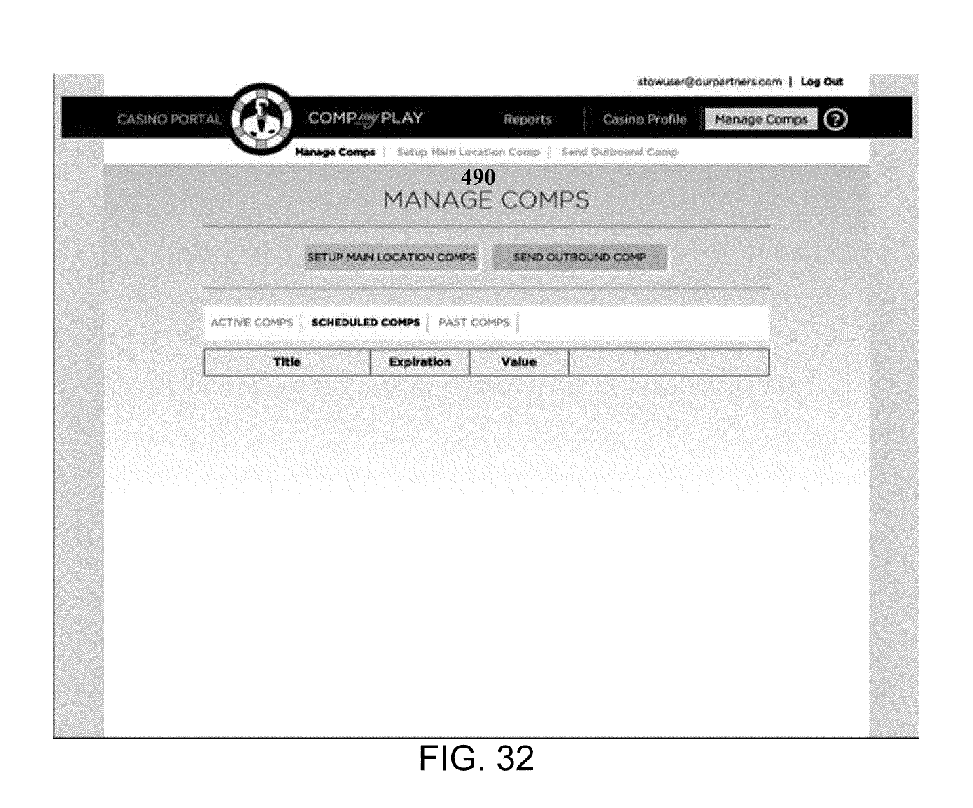

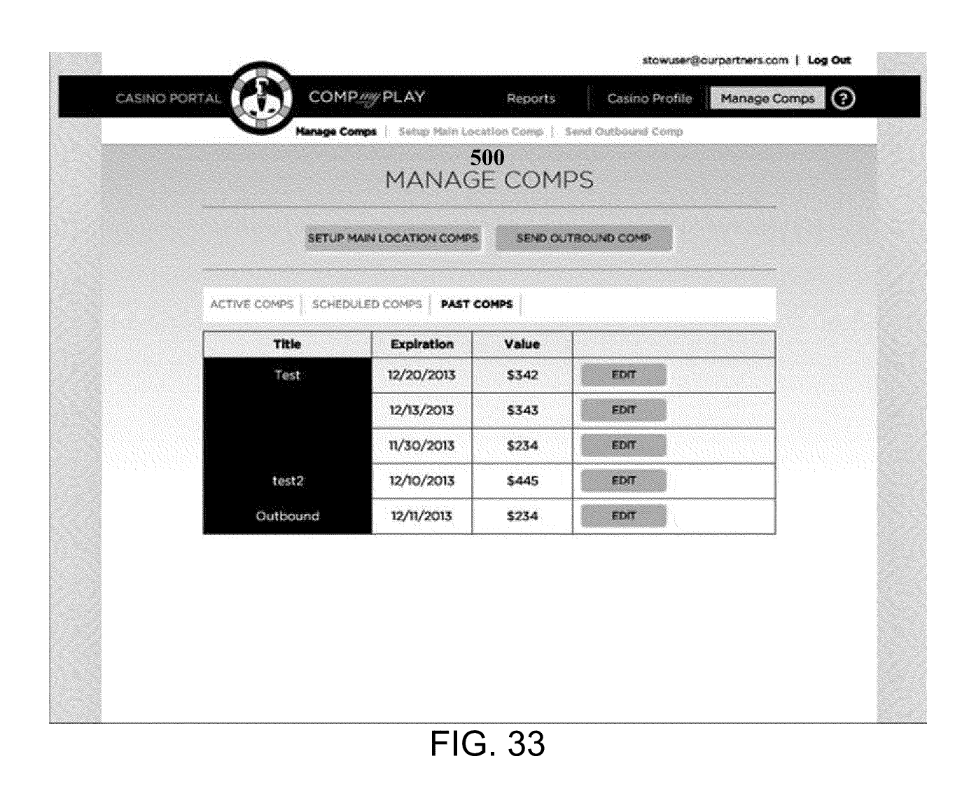

FIG. 31 depicts a screen image from an electronic device 30 depicting the manage comps: active comps page 480 for the comp allotting application in accordance with one embodiment. A casino administrator may access this page by engaging the manage comps tab and manage comps sub tab. The comps table 481 found on the page may display the comps active tab for a casino, including an expiration date and a value of the comps. A casino administrator may also have the option to edit or end any of the comps. FIG. 32 depicts a screen image from an electronic device 30 depicting the manage comps: scheduled comps page 490 for the comp allotting application in accordance with one embodiment. This page may be displayed by engaging the scheduled comps tab adjacent the comps active tab for a casino. The titles, expiration dates, and values may be seen for the scheduled comps. FIG. 33 depicts a screen image from an electronic device 30 depicting the manage comps: past comps page 500 for the comp allotting application in accordance with one embodiment. This page may be displayed by engaging he past comps tab adjacent the scheduled comps tab. Comps that have expired, whether claimed or not by a user, may be displayed.

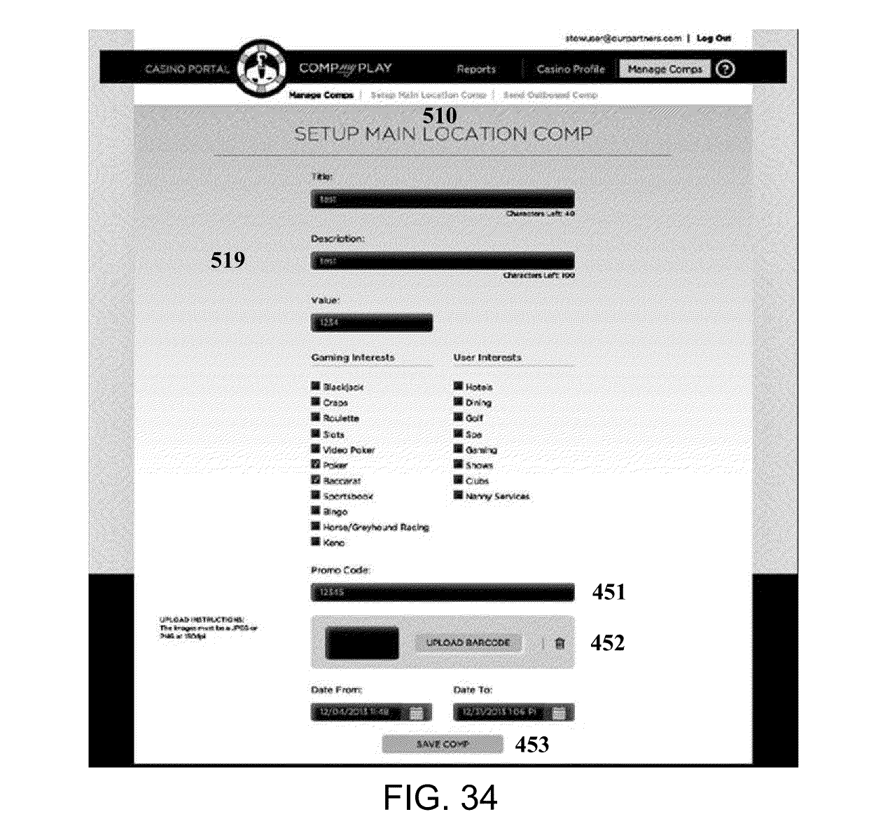

FIG. 34 depicts a screen image from an electronic device 30 depicting the setup main location comp page 510 for the comp allotting application in accordance with one embodiment. This page may be accessed under the manage comps tab and setup main location comp sub-tab. Using this page, a casino administrator may create a casino comp by inputting a title, description, and value of the comp in the information section 519. Dates of availability for the comp may be input as well using engageable drop-down menus found at the bottom of the page. The administrator may add gaming interests and user interests that may be used to match users with the comp by matching the gaming interests/preferences and user interests/preferences with a user's chosen preferences in the CompMyPlay™ user application. Further, a promo code may be added in the promo code section 451 that is used for the identification of comps and may be found on a comp voucher. When a user redeems a comp at a casino, the casino may identify and properly redeem the comp using the promo code. Below the promo code section 451 is an upload barcode section 452, wherein a casino administrator may upload a barcode that may also be used for identification of comps and may be found on a comp voucher. When a user redeems a comp at a casino, the casino may identify and properly redeem the comp using the barcode. At the bottom of the page, the administrator may engage the save comp icon 453 to save the entered preferences of the comp.

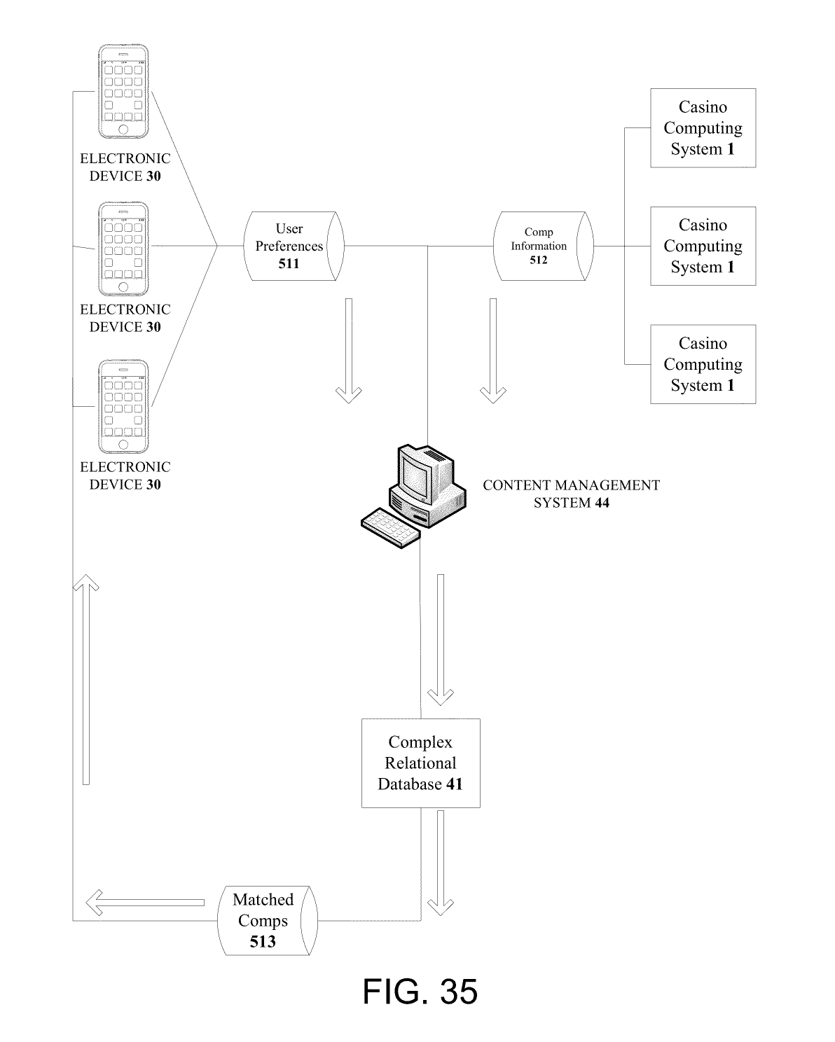

FIG. 35 depicts a flow diagram depicting the path of a comp from a casino to a matched user. One or more casinos may create a comp by inputting comp information 512 using the setup main location comp page 510 and storing the comp information 512 on one or more system memories 4 of the one or more computing systems 1 of the casinos. One or more users may input user preferences 511 on their electronic devices 30 using the “In the Area” page 230. When the user preferences 511 from the “In the Area” page 230 are received by the complex relational database 41 via the Content Management System 44. When the complex relational database 41 needs comps to match the user preferences 511, the Content Management System 44 accesses the one or more casino computing systems 1 and extracts the comp information 512. Once the complex relational database 41 receives the comp information 512, the complex relational database 41 may match the user preferences 511 and comp information 512 by matching preferences that are similar and/or the same in both the user preferences 511 and comp information 512. Matched comps 513 are then sent to the one or more electronic devices 30 of users that may be found on the “In the Area” comp results page 250.

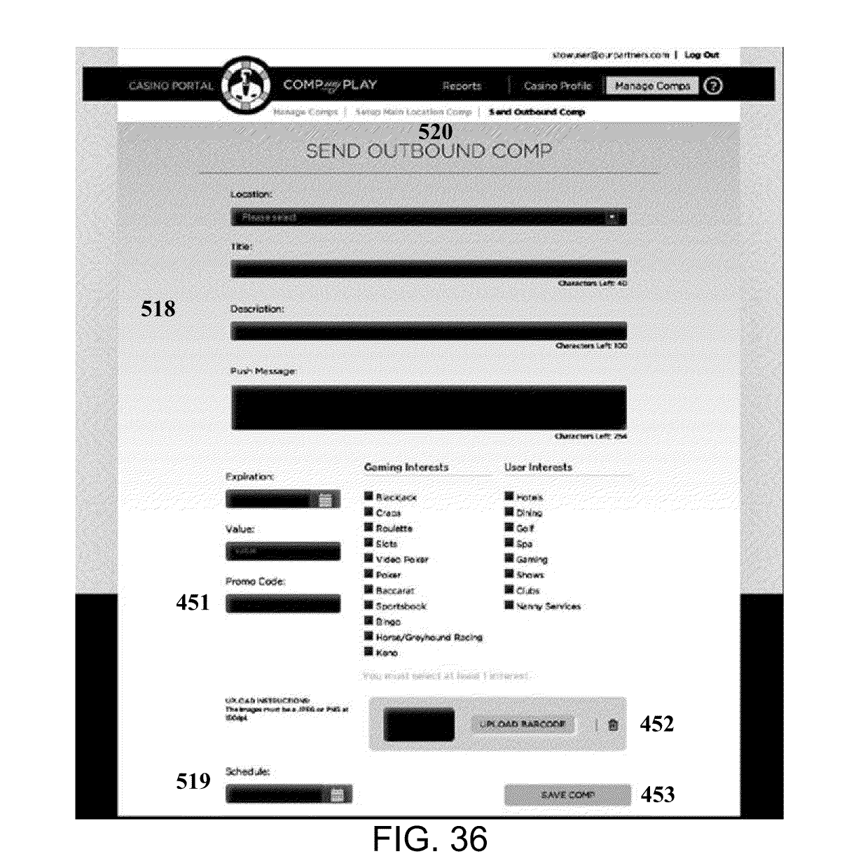

FIG. 36 depicts a screen image from an electronic device 30 depicting the send outbound comp page 520 for the comp allotting application in accordance with one embodiment. This page may be accessed under the manage comps tab and send outbound comp sub-tab. Using this page, a casino administrator may create a comp by inputting preferences into the computing system 1 of the casino. Using this page, a casino administrator may create a casino comp by inputting a location, title, description, and a push message in the information section 518. Further, the expiration date of the comp, value of the comp, and a promo code section may be utilized for the comp. The administrator may add gaming interests and user interests that may be used to match users with the comp by matching the gaming interests/preferences and user interests/preferences with a user's chosen preferences in the CompMyPlay™ user application. Further, a promo code may be added in the promo code section 451 that is used for the identification of comps and may be found on a comp voucher. When a user redeems a comp at a casino, the casino may identify and properly redeem the comp using the promo code. Below the promo code section 451 is an upload barcode section 452, wherein a casino administrator may upload a barcode that may also be used for identification of comps and may be found on a comp voucher. When a user redeems a comp at a casino, the casino may identify and properly redeem the comp using the barcode. A schedule section 519 is found in the bottom left hand side of the page that may allow a casino administrator to schedule a specific time range and place for a push message to be sent. At the bottom of the page, the administrator may engage the save comp icon 453 to save the entered preferences of the comp.

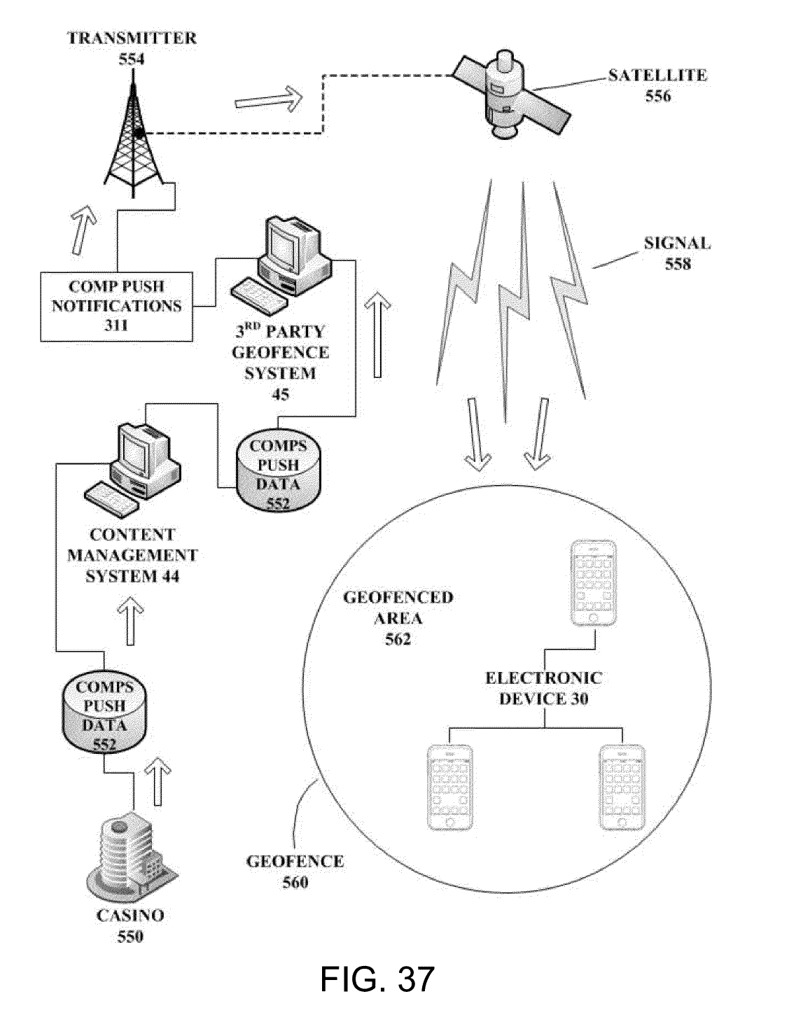

FIG. 37 depicts a flow chart of the process of sending a comp push notification to a user's electronic device 30. A casino may fill out and save a comp created in the send outbound comp page 520. This comp information may be sent as comps push data 552 to the CompMyPlay™ Content Management System 44 when the time in which the casino administrator input into the schedule section 519 is reached. Once the comps push data 552 is received by the content management system 44, the comps push data 552 is sent to the 3^{rd} party geofence system 45, wherein the area input into the schedule section 519 is analyzed and correlated to a specific geofence for that area. Once a geofence is correlated for the comp push data 552, a comp push notification 311 may be sent through a transmitter 554 to a satellite 556. The satellite 556 may send the signal 558 representative of a comp push notification 311 to electronic devices 30 located in the geofence 560. Any electronic devices 30 found in the geofenced area 562 at any point in time within the time range entered by the casino administrator. The geofenced areas 562 may allow a casino to spread its influence to potential clients that would normally not be accessible.

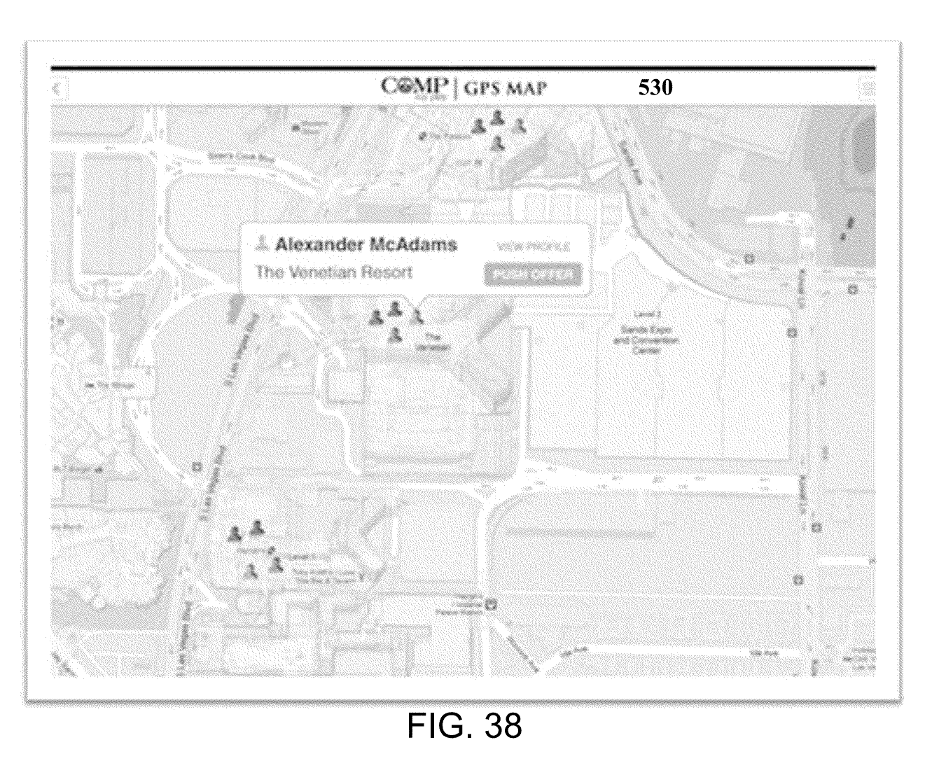

FIG. 38 depicts a screen image from an electronic device 30 depicting a GPS map 530 for the comp allotting application in accordance with one embodiment. This interactive GPS map 530 may be accessed within the casino administration portal and may show active CompMyPlay™ users. The users shown exist in a specific geofenced area 562, meaning that push notifications may be sent to one or more of these users.

III. CompMyPlay™ Administrator Experience

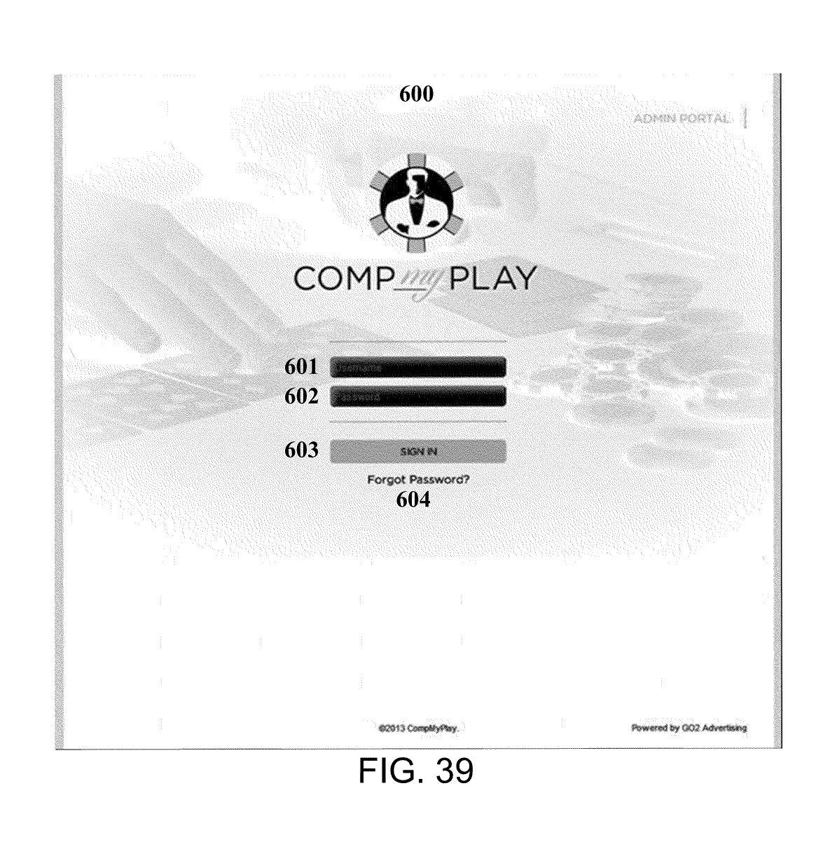

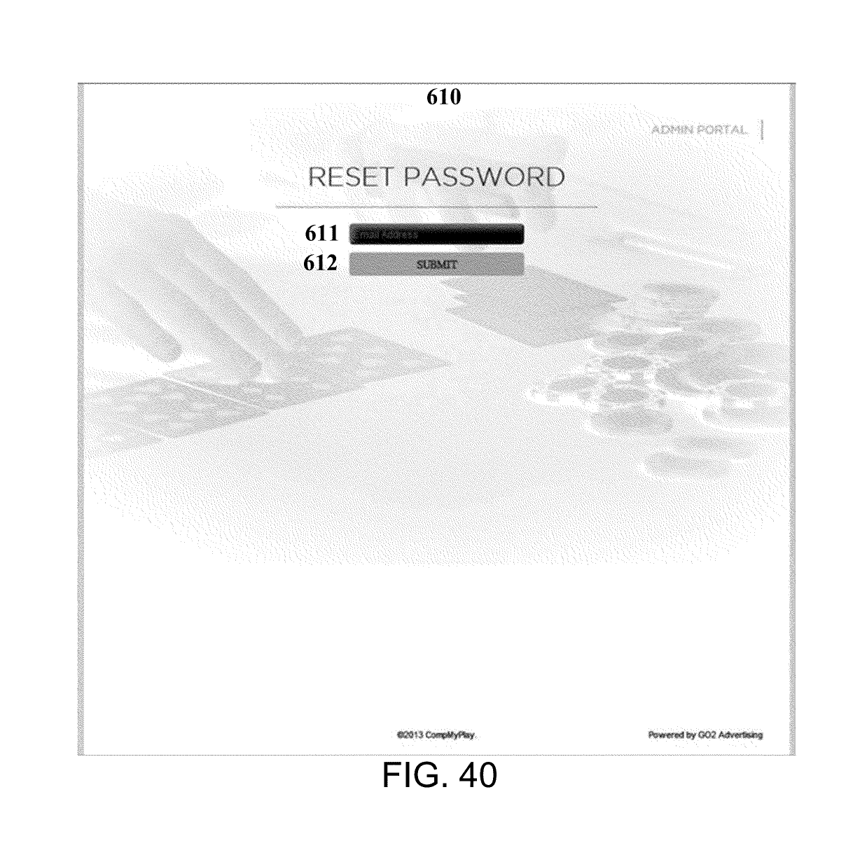

FIG. 39 depicts a screen image from an electronic device 30 depicting the CompMyPlay™ Administration log-in page 600 for the comp allotting application in accordance with one embodiment. This log-in page 600 is designed for CompMyPlay™ administrators to log into the CompMyPlay™ network. The middle of the screen image depicts engageable fill-in sections 601 and 602, wherein a CompMyPlay™ administrator may input an email address and password exclusive to a casino account. Once the fill-in sections 601 and 602 are properly filled out, a CompMyPlay™ administrator may engage the sign in icon 603 and be led away from the screen image. If a CompMyPlay™ administrator has forgotten the password used to login, the CompMyPlay™ administrator may engage the forgot password icon 604, wherein the casino administrator may be taken to the reset password page 610 found in FIG. 40. A CompMyPlay™ administrator may then enter an email address into the email section 611 that may be accessed by the CompMyPlay™ administrator. Once the submit icon 612 is engaged, an email will be sent to the email address entered in the email section 611 to allow a casino administrator to change the password.

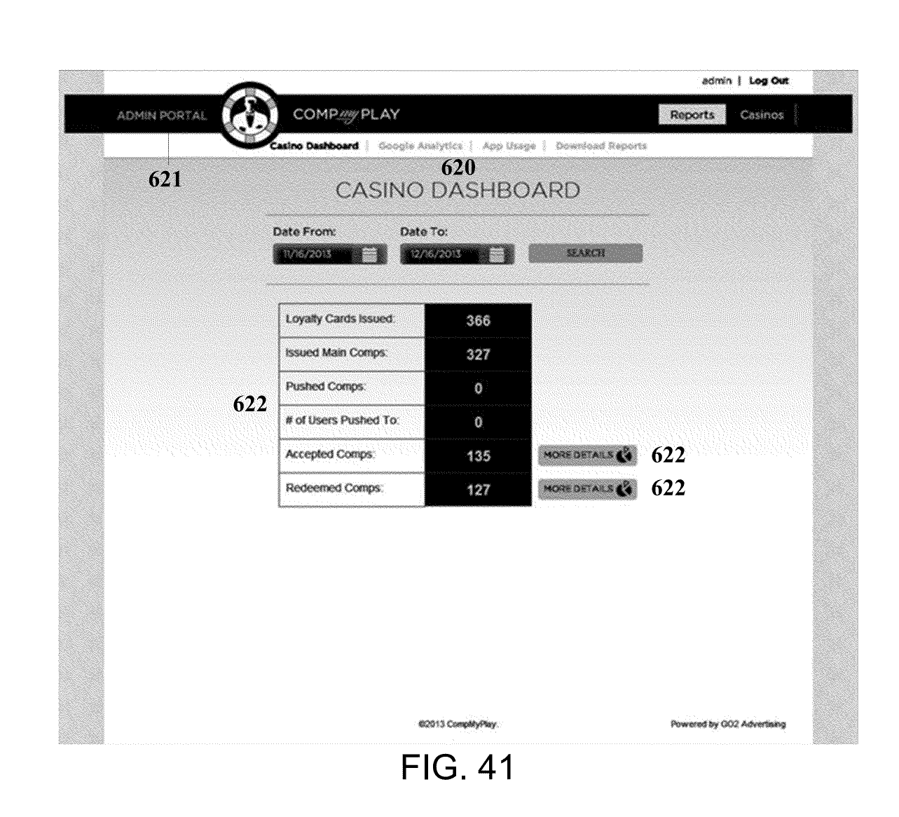

FIG. 41 depicts a screen image from an electronic device 30 depicting the CompMyPlay™ Administration casino dashboard page 620 for the comp allotting application in accordance with one embodiment. The casino dashboard page 620 may be accessed by first engaging the reports tab on the CompMyPlay™ administration title bar 621 and subsequently engaging the casino dashboard tab under the reports tab. A CompMyPlay™ administrator may utilize the date engageable icons in order to input a timeframe. Once the timeframe is input and the search icon is engaged, a comps chart 622 will appear on the casino dashboard page 620 that displays statistics such as, but not limited to, loyalty cards issued, issued main comps, pushed comps, number of users pushed to, accepted comps, and redeemed comps.

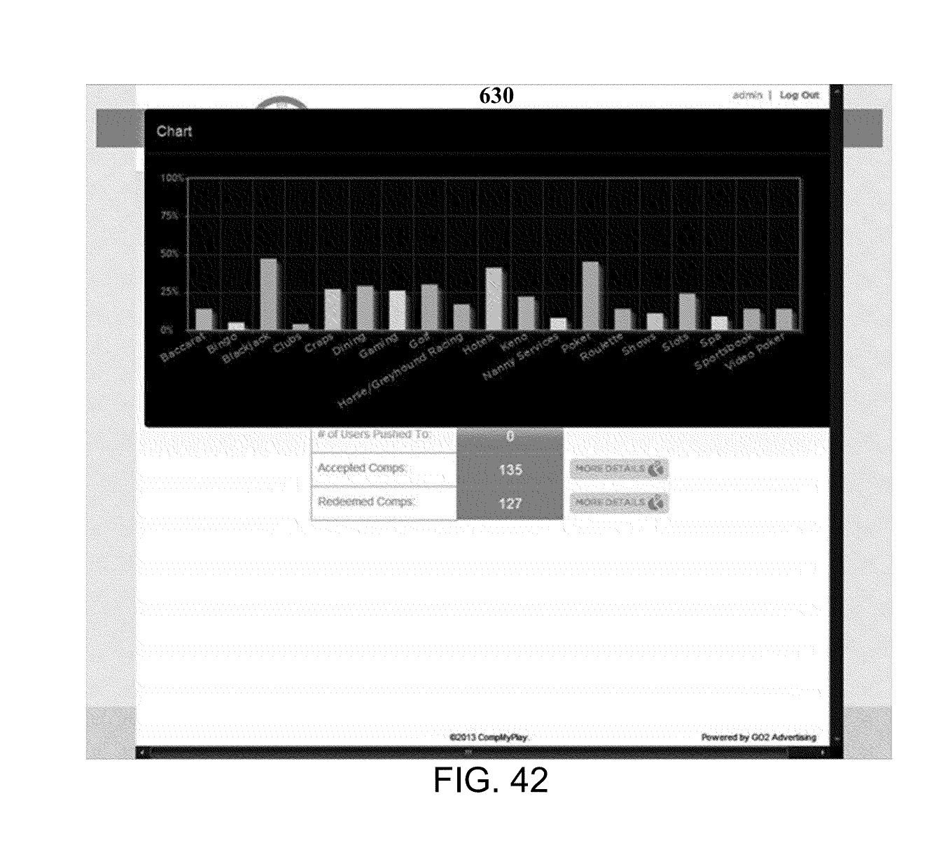

Further details for the accepted comps and redeemed comps may be shown by engaging the more details icon 622 next to each statistics category. In other embodiments, details for one or more of the statistics categories may be shown by engaging a more details icon 622 next to each category. When a CompMyPlay™ administrator engages a more details icon 622, a screen image of a statistics chart will appear over part of the casino dashboard page 620; this page is referred to as the comps statistics page 630 found in FIG. 42. The chart may display a graph depicting statistics for a specific comp category. For example, the graph displayed in FIG. 42 depicts the percentage of specific comps that have been accepted from a specific hotel.

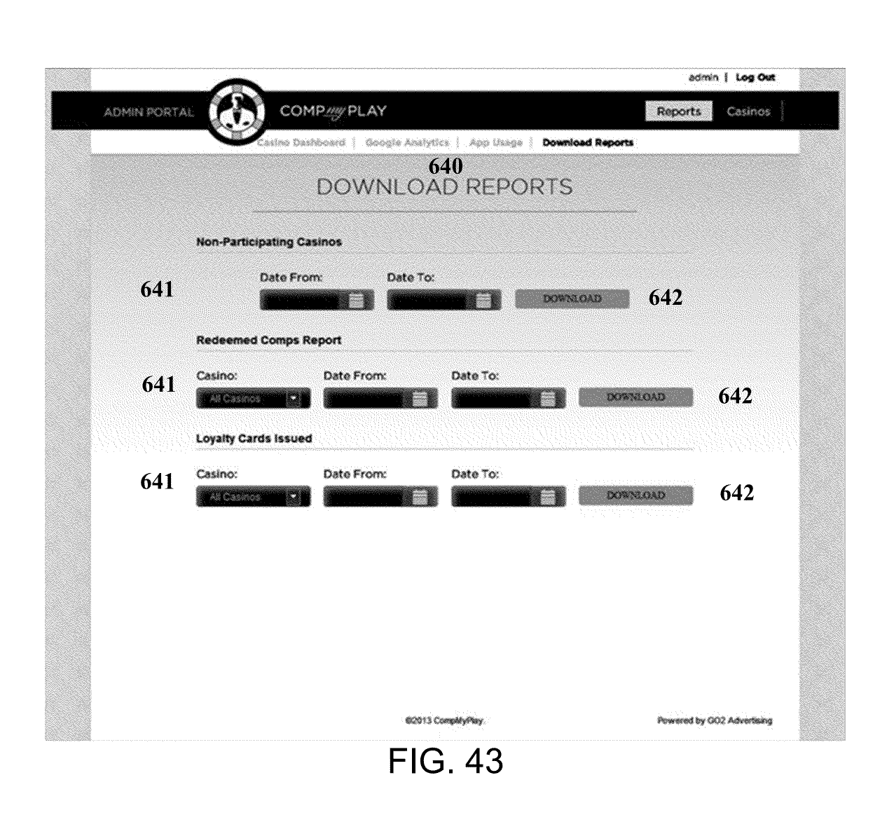

FIG. 43 depicts a screen image from an electronic device 30 depicting the reports download page 640 for the comp allotting application in accordance with one embodiment. When a CompMyPlay™ administrator engages the download reports page tab located adjacent to the casino dashboard tab, a report related to either redeemed comps or loyalty cards may be downloaded. The specificity of the reports may be related to the timeframe that a casino administrator inputs into one or more time entering sections 641. A CompMyPlay™ administrator may download the one or more reports by engaging a download icon 642 located adjacent to the time entering section 641.

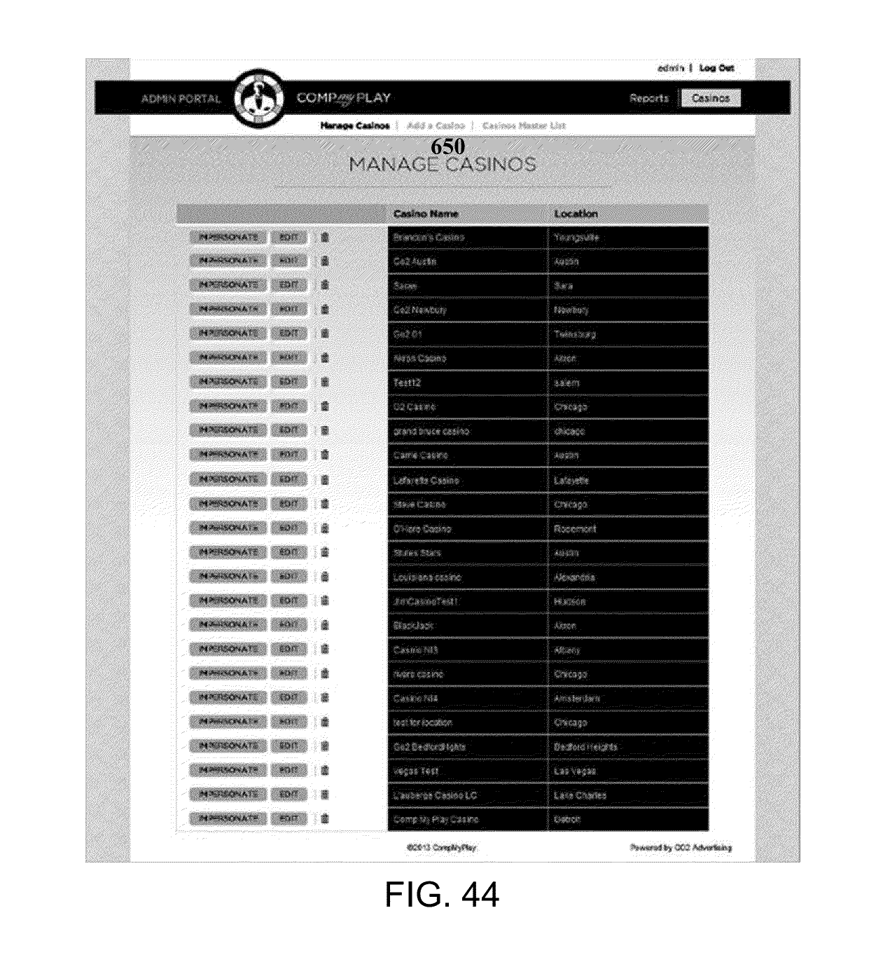

FIG. 44 depicts a screen image from an electronic device 30 depicting the CompMyPlay™ Administration manage casinos page 650 for the comp allotting application in accordance with one embodiment. The manage casinos page 650 may be accessed by first engaging the casinos tab on the CompMyPlay™ administration title bar 621 and subsequently engaging the manage casinos tab under the casinos tab. The manage casinos chart depicts a list of the casinos that are signed up with the CompMyPlay™ service at the time of accessing the manage casinos tab. The casinos are separated by name; the location of each casino listed may be found adjacent to the casino name. To the left of the manage casinos chart, the CompMyPlay™ administrator may engage either an “IMPERSONATE” icon, an “EDIT” icon, or a trashcan icon; these options icons are located next to each separate casino name.

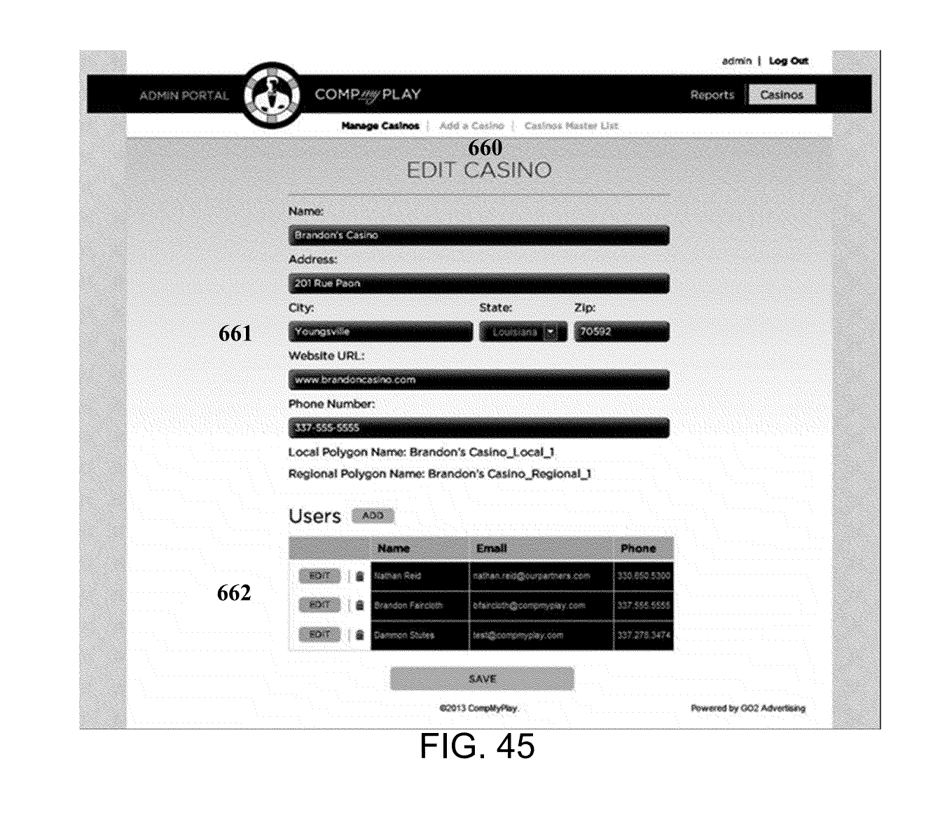

When the “EDIT” icon is engaged by a CompMyPlay™ administrator, the administrator may be led to the screen image depicted in FIG. 45 known as the edit casinos page 660. Once on this page, the administrator may alter information pertinent to the casino in the general information section 661 that includes information such as, but not limited to, the name, address, city, state, zip code, website URL, or phone number of the casino. Below the general information section 661 is the casino administrator section 662 that allows a CompMyPlay™ administrator to add casino administrators that will give each entered casino administrator access to a specific casino portal.

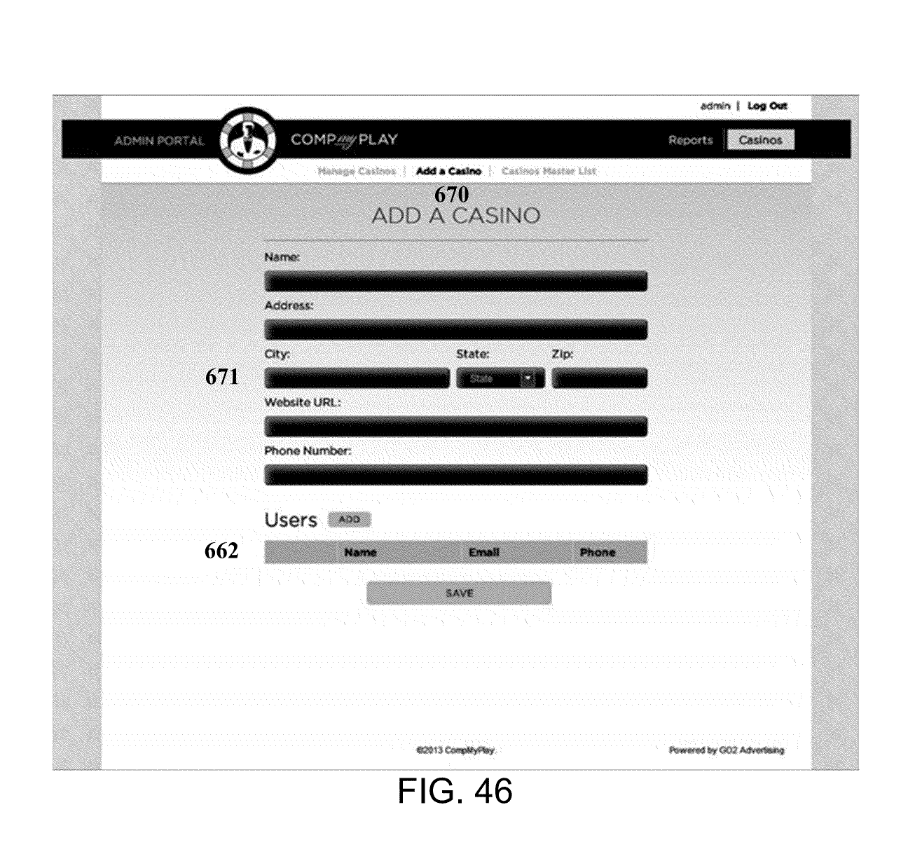

FIG. 46 depicts a screen image from an electronic device 30 depicting the CompMyPlay™ Administration add a casino page 670 for the comp allotting application in accordance with one embodiment. Using this page, a CompMyPlay™ administrator may add pertinent information for a casino in the new casino information section 671. This information may include, but is not limited to, the name of the casino, address of the casino, city of the casino, state of the casino, zip code of the casino, website URL of the casino, and phone number of the casino. Below the new casino information section 671 is the casino administrator section 662 that allows a CompMyPlay™ administrator to add casino administrators that will give each entered casino administrator access to a specific casino portal.

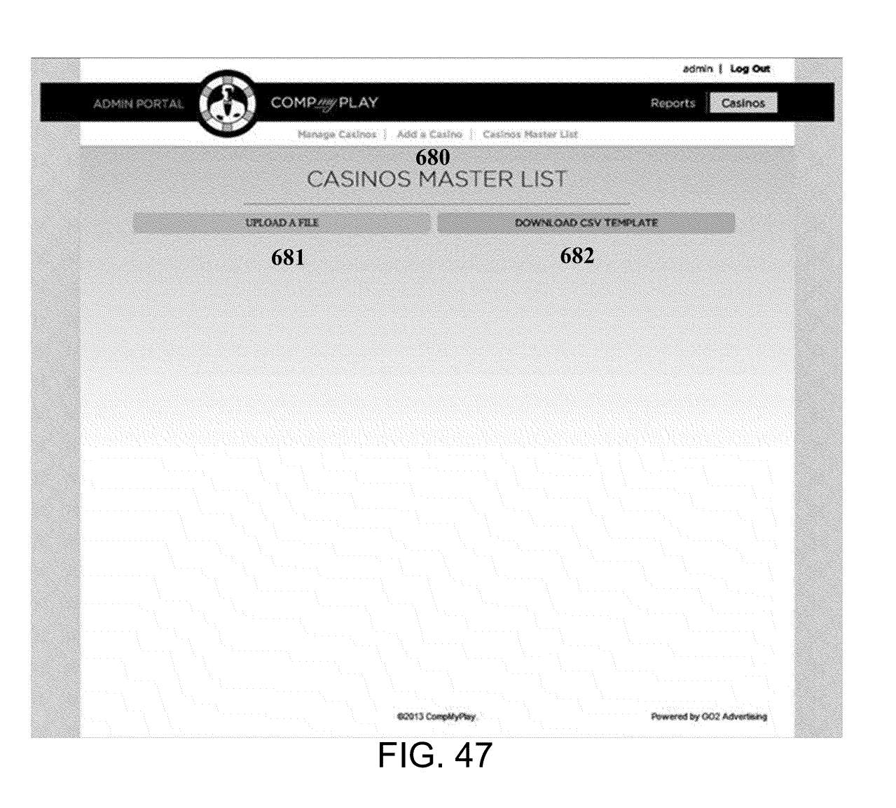

FIG. 47 depicts a screen image from an electronic device 30 depicting the CompMyPlay™ Administration casinos master list page 680 for the comp allotting application in accordance with one embodiment. Using this page, a CompMyPlay™ administrator may view the list of casinos utilizing CompMyPlay™ as well as upload a casino file or download a casino .csv file by engaging either the upload a file icon 681 or the download .csv template icon 682.

For the purposes of this disclosure, the terms “comp” and “comp reward” refer to a promotional offer created by a casino and offered to an individual.

For the purposes of this disclosure, the framework of the application disclosed in relation to a mobile electronic device may be created using either a basis comprising embedded dynamic websites or a basis comprising device-specific languages. For example, the application may be created using PhoneGap® (a registered trademark of Adobe Systems Incorporated) when it is desired that the application be used on more than one mobile device platform. As another example, Objective-C® (a registered trademark of Apple Inc.) may be implemented when it is desired that the application be used on a mobile device such as an Iphone® (a registered trademark of Apple Inc.).

For the purposes of this disclosure, the terms “comp offer” and “comp package” are synonymous and may therefore be used interchangeably.

For the purposes of this disclosure, the term “administration account” may refer to an account used to log into the CompMyPlay™ network in order to interact with the network interface.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

The use of any and all examples, or exemplary language (e.g., “such as”), is intended merely to better illustrate the disclosure and does not pose a limitation on the scope of the disclosure unless otherwise claimed. No language in the specification should be construed as indicating any non-claimed element as essential to the practice of the disclosure as used herein.

What is claimed is:

1. A method for matching, aggregating, and distributing at least one comp offer comprising:
building at least one comp offer using a computing system;
sending at least one comp offer to a content management system via a network interface, wherein the content management system comprises a complex relational database, further wherein the complex relational database matches the at least one comp offer to a user;
providing information to a non-transitory computer usable storage medium in an electronic device regarding criteria of the user, wherein the criteria comprises at least one predetermined parameter and the non-transitory computer usable storage medium comprises a link to the complex relational database;
sending the information to the complex relational database via the link;
displaying to the user, via the non-transitory computer usable storage medium, elements in a virtual cache representative of at least one comp offer, wherein the nature of the displayed at least one comp offer is dependent on the at least one predetermined parameter;
receiving from the non-transitory computer usable storage medium via the network interface an indication that the user of the electronic device accepted one or more of the at least one comp offer;
generating at least one comp offer voucher pertaining to the one or more accepted comp offers using the content management system;
sending the at least one comp offer vouchers pertaining to the at least one accepted comp offers to the electronic device via the network interface;
and
allowing the user to remove the at least one comp offer voucher from the virtual cache and deposit the comp offer voucher in a storage medium of the electronic device.

2. The method of claim 1 wherein each of the at least one comp offers is a push notification created by the computing system.

3. The method of claim 1 further comprising sending the push notification, via a third party geofence system, to at least one electronic device located in a geofenced area.

4. The method of claim 1 wherein the user may store at least one comp reward on the storage medium via the electronic device.

5. The method of claim 1 wherein the user is restricted from depositing more than one comp reward voucher in the storage medium of the electronic device.

6. The method of claim 1 wherein the nature of the displayed comp reward is dependent on the current location of the location-capable wireless device.

7. The method of claim 1 wherein the at least one predetermined parameters is the user's interests and playing habits information provided to the non-transitory computer usable storage medium by the user.

8. The method of claim 1 wherein the at least one predetermined parameters is the user's preferences and desired destination for a trip.

9. A system comprising:
a memory;
a display; and
a processor, wherein the processor is operably connected with the memory and the display, and the processor is configured to:
receive preference data for a user, wherein the preference data includes at least one preference pertaining to a comp offer;
dynamically correlate at least a portion of the preference data for a comp offer using a network interface that interfaces with a complex relational database, wherein the preference data is correlated with the comp offer using one or more algorithms;
and
display at least a portion of the dynamically correlated preference data and comp offer using the display, wherein the network interface is driven by a content management system.

10. The system of claim 9 wherein the content management system is accessed using an administration account.

11. A computer program product comprised of a non-transitory computer usable storage medium having computer readable program code embodied in the medium, the computer readable program code comprising:
computer readable program code that builds more than one comp offer using a processor;
computer readable program code that sends the more than one comp reward to a content management system via the network interface;
computer readable program code that provides information to the content management system regarding criteria of a user, wherein the criteria comprises at least one predetermined parameter;
computer readable program code that displays to the user via the wireless device elements in a virtual cache representative of a comp offer, wherein the displayed comp reward is dependent on the at least one predetermined parameter;
computer readable program code that receives from the content management system via the network interface an indication that the user of a content management system application accepted the comp offer;
computer readable program code that builds a comp offer voucher pertaining to the accepted comp offer using the processor;
computer readable program code that sends the comp offer voucher pertaining to the accepted comp offer to the content management system via the network interface;
and
computer readable program code that allows the user to remove the comp offer voucher from the virtual cache and deposit the comp offer voucher in a storage medium of the location-capable wireless device.

12. The computer program product of claim 11 at least one comp offer may be stored on the storage medium of a location-capable wireless device via the network interface.

13. The computer program product of claim 11 wherein the user is restricted from depositing more than one comp offer voucher in the storage medium of a location-capable wireless device.

14. The computer program product of claim 11 wherein the displayed comp offer is dependent on the current location of the location-capable wireless device.

15. The computer program product of claim 11 wherein the at least one predetermined parameter is the user's interests and playing habits information provided to the content management system by the user.

16. The computer program product of claim 11 wherein the at least one predetermined parameter is the user's preferences and desired destination for a trip.

17. A computer program product comprised of a non-transitory computer usable storage medium having computer readable program code embodied in the medium, the computer readable program code comprising:
computer readable program code that builds more than one comp offer using a processor;
computer readable program code that sends the more than one comp offer to a content management system via the network interface;
computer readable program code that confirms that the user is located in a specific geographical area, comprising receiving a message from a location-capable wireless device transmitted over a location-capable wireless network, wherein the message includes information as to a current location of the location-capable wireless device;
computer readable program code that displays to the user via the wireless device elements in a virtual cache representative of a comp offer, wherein the displayed comp offer is dependent on the current location of the location-capable wireless device;
computer readable program code that receives from the content management system via the network interface an indication that the user of a content management system application accepted the comp offer;
computer readable program code that builds a comp offer voucher pertaining to the accepted comp offer using the processor;
computer readable program code that sends the comp offer voucher pertaining to the accepted comp offer to the content management system via the network interface;
and
computer readable program code that allows the user to remove the comp offer voucher from the virtual cache and deposit the comp offer voucher in a storage medium of the location-capable wireless device.

18. The computer program product of claim 17 wherein the comp offer may be in the form of a push notification.

19. The computer program product of claim 17 wherein the user may store at least one comp offer on the storage medium of the location-capable wireless device via the network interface.

20. The computer program product of claim 17 wherein the user is restricted from depositing more than one comp offer voucher in the storage medium of the location-capable wireless device.

21. The computer program product of claim 17 wherein the displayed comp reward is dependent on at least one predetermined parameter, wherein the at least one predetermined parameter is the user's interests and playing habits information provided to the content management system by the user.

22. The computer program product of claim 17 wherein the at least one predetermined parameter is the user's preferences and desired destination for a trip.
